(19) United States
(12) Patent Application Publication
(10) Pub. No.: US 2026/0286076 A1
(43) Pub. Date: Sep. 24, 2026

(54) POLYAMIDE-BASED MIXED MATRIX MEMBRANE FOR OIL-WATER SEPARATION

(71) Applicant: King Fahd University of Petroleum and Minerals, Dhahran (SA)

(72) Inventors: Hassan YOUNAS, Dhahran (SA); Abdul WAHEED, Dhahran (SA); Umair BAIG, Dhahran (SA); Isam H. ALJUNDI, Dhahran (SA)

(73) Assignee: King Fahd University of Petroleum and Minerals, Dhahran (SA)

(21) Appl. No.: 19/085,780

(22) Filed: Mar. 20, 2025

(51) Int. Cl. C08J 5/22; B01D 69/12; B01D 71/34; B01D 71/56; C08G 69/28

(52) U.S. Cl. CPC C08J 5/2268; B01D 69/1216; B01D 71/34; B01D 71/56; C08G 69/28; B01D 2325/0231; B01D 2325/0283; C08G 2340/00; C08J 2327/16; C08J 2377/10

(57) ABSTRACT

A mixed matrix membrane includes a polymer comprising reacted units of a 3,5-diaminobenzoic acid and isophthaloyl chloride in a molar ratio of 5:1 to 1:5 and a polyvinylidene fluoride. A weight ratio of the polymer to the polyvinylidene fluoride is from 1:1 to 1:20 based on a total weight of the polymer and the polyvinylidene fluoride. The polymer and the polyvinylidene fluoride form a trilayer structure of horizontal layers with a first porous outer layer of the polyvinylidene fluoride and a second porous outer layer covering a porous inner layer of the polymer. The first porous outer layer has a pore size with a longest dimension of 3 to 30 μm, the second porous outer layer has a pore size with a longest dimension of 1 to 10 μm, and the porous inner layer has void spaces having an average longest dimension of from 20 to 500 μm.

### STATEMENT REGARDING PRIOR DISCLOSURE BY THE INVENTORS

Aspects of the present disclosure are described in Younas, H. et al., “Condensation polymerization of 3,5-diaminobenzoic acid and isophthaloyl chloride yielding hydrophilic polyamide and its decoration in polyvinylidene difluoride membranes for the efficient separation of stable oil/water emulsions” published in Volume 361, Separation and Purification Technology (2025), which is incorporated herein by reference in its entirety.

### STATEMENT OF ACKNOWLEDGEMENT

Support provided by the Interdisciplinary Research Center of Membranes and Water Security, King Fahd University of Petroleum and Minerals, Saudi Arabia, through Project INMW2403 is gratefully acknowledged.

### BACKGROUND

### Technical Field

The present disclosure is directed towards a method for making and a composition for a polyamide-based mixed matrix membrane and, more particularly, to the use of a polymer containing reacted units of 3,5-diaminobenzoic acid (DABA) and isophthaloyl chloride (IPC) containing hydrophilic polyamide for making a membrane and its use for decorating a polyvinylidene fluoride (PVDF) membrane for efficient treatment of emulsified oily wastewater streams.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Demand for efficient separation technologies for oil-in-water (O/W) emulsions has increased in recent years due to rising concerns related to environmental pollution and diminishing sources of clean water. Several industries, including petroleum refining, petrochemicals, and wastewater treatment plants, release abundant amounts of O/W emulsions, which result in treatment challenges for conventional separation methods. The petroleum industry generates a large amount of produced water (PW) streams, which are generated due to drilling operations, with 2 to 3 barrels of produced water being generated per barrel of drilled oil. The situation becomes intense when the availability of scare freshwater is coupled with an additional bill for managing the oily wastewater generated as PW. Given the complex nature of oily wastewater streams and the potential of recovering water from these streams, various technologies have been developed over the years; however, with changing environmental factors and ever-increasing environmental regulations, there is a need for the development of advanced separation technologies capable of achieving high efficiency, selectivity, and environmental sustainability.

Membrane-based separation processes have emerged as promising solutions to address challenges related to the treatment of O/W emulsions. Membranes offer several advantages, including high separation efficiency, ease of scalability, cost-effectiveness, low energy consumption, minimal space requirements, and reduced environmental footprints. Minimal concentrations of chemicals are needed for membrane surface cleaning. A variety of membranes have been developed for treating O/W emulsions, including polymeric, ceramic, and hybrid polymeric-ceramic membranes. Membrane separation is a pressure-driven process that can be used for treating a variety of feeds. Seawater can be cleaned by reverse osmosis (RO) and nanofiltration (NF) membranes. Ultrafiltration (UF) membranes have slightly wider pores and have been used for treating domestic wastewater in the form of a membrane bioreactor (MBR) and for treating oily wastewater by separating the O/W emulsions. Different polymeric membranes such as polyvinylidene difluoride (PVDF), polyether sulfone (PES), cellulose acetate (CA), and polyacrylonitrile (PAN) have been used for fabricating the UF membranes for O/W emulsion separation. UF polymeric membranes, such as CA membranes, are promising for treating oily wastewater streams owing to the presence of several hydroxyl (—OH) functional groups in the structure of the CA membrane that can generate hydrogen bonds with water molecules to generate a hydration layer on the membrane surface. The presence of a hydration layer on the membrane surface does not allow oil to encounter the membrane surface, leading to reduced fouling of the membrane during O/W separation experiments. The hydrophilicity of the CA membrane was not enough and the oil droplets present in the O/W emulsion were deposited on the membrane surface causing a decrease in permeate flux and lowering the separation efficiency of the membrane. Efforts for developing new membranes with improved separation features, such as hydrophilicity and stable performance under real-life conditions are needed.

Numerous approaches have been adopted to enhance the performance of membranes, including varying the chemistry and structure of the surface of the membranes, such as grafting the surface of membranes [Chen, W. et al., The improved oil/water separation performance of cellulose acetate-graft-polyacrylonitrile membranes, Journal of Membrane Science, 2009, 337, 98-105; and Soyekwo, F. et al., Fouling-resistant ionic graft-polyamide nanofiltration membrane with improved permeance for lithium separation from MgCl₂/LiCl mixtures, Journal of Membrane Science, 2022, 659, 120773], chemically treating the surface of membranes [Gryta, M., Surface modification of polypropylene membrane by helium plasma treatment for membrane distillation, Journal of Membrane Science, 2021, 628, 119265; and Ren, Y. et al., Tuning pore size and surface charge of poly(piperazinamide) nanofiltration membrane by enhanced chemical cleaning treatment, Journal of Membrane Science, 2022, 643, 120054], and coating polymers on the membrane surface [Younas, H. et al., Super-hydrophilic and fouling resistant PVDF ultrafiltration membranes based on a facile prefabricated surface, Journal of Membrane Science, 2017, 541 529-540]. These techniques are useful, but they are sophisticated for surface grafting a membrane to have specific functional groups on the surface of the membrane. In contrast to surface grafting and modification of membranes, mixing and blending polymers and additives are the easiest, most scalable, and most widely applied approaches in membrane science due to their simplicity and cost-effectiveness. Blending has a potential to combine properties of different polymers and/or additives to develop advantageous membranes called mixed matrix membranes (MMMs) [Li, H., et al., Organic-inorganic composite ultrafiltration membrane with anti-fouling and catalytic properties by in-situ co-casting for water treatment, Journal of Membrane Science, 2022, 662, 120984; and Pandey, R. P. et al., A fouling-resistant mixed-matrix nanofiltration membrane based on covalently cross-linked Ti₃C₂TX (MXene)/cellulose acetate, Journal of Membrane Science, 2020, 607, 118139].

Nanofillers, including metal-organic frameworks (MOFs), covalent organic frameworks (COFs), carbon nanotubes (CNTs), graphene oxide (GO), clays (like bentonite), and ceramic materials (like silicon carbide (SiC)), have been used to decorate a matrix of polymeric membranes for developing efficient membranes; however, these nanofillers, especially ones with an inorganic nature, face challenges like tedious and complicated synthesis steps coupled with harsh conditions, which make their synthesis and application on a large scale more challenging. Their inorganic nature also reduces homogeneity with an organic polymeric matrix, which may lead to defects owing to nanoparticle agglomeration. MMMs can synergistically combine advantages of participating components, resulting in improved separation performance and mechanical properties of membranes. Integration and decoration of hydrophilic polymers, such as polyamides, stands out as a promising strategy for enhancing separation efficiency of MMMs for O/W emulsions. Hydrophilic polyamides, characterized by polar functional groups, such as carboxylic (—COOH) and amide linkages (—CONH), have a strong affinity towards water molecules and offer advantages when incorporated into membrane structures [Rajasekhar, T. et al., Oil-water emulsion separation using ultrafiltration membranes based on novel blends of poly(vinylidene fluoride) and amphiphilic tri-block copolymer containing carboxylic acid functional group, Journal of Membrane Science, 2015 481, 82-93; and Helali, N. et al., Development of underwater superoleophobic polyamide-imide (PAI) microfiltration membranes for oil/water emulsion separation, Separation and Purification Technology, 2020, 238, 116451]. Polyamides enhance membrane surface hydrophilicity and facilitate interactions with water molecules through hydrogen bonding and electrostatic interactions. The organic nature of the polyamides increase homogeneity between the base polymer (the matrix) and an additive polymer (the filler, polyamide in this case). An added advantage of filler polyamides is ease of varying the chemistry of the polyamides to further enhance the performance and properties of the membranes.

Incorporating hydrophilic polyamides into MMMs develops a hydrophilic surface leading to selective permeation of water while repelling oil molecules. This selectivity arises from preferential interactions between polar functional groups (i.e., —COOH and —CONH) of hydrophilic polyamides and water molecules. These interactions facilitate transport of water molecules through membranes while hindering the passage of oil droplets due to the oil droplets not being able to wet the membrane surface. The presence of the hydrophilic polyamides in the membrane matrix will assist in mitigating fouling tendencies of the membrane by avoiding adhesion of foulants (such as emulsified oil droplets) to the membrane surface, which may enhance membrane life and stability during filtration. In addition to enhancing the hydrophilicity of the membrane, another challenge is to develop UF membranes that can be installed in crossflow filtration mode. Mesh membranes using gravity to separate O/W emulsions may not be likely in real-world applications where oily wastewater is available in barrels [Zhang, X. et al., UiO-66-Coated Mesh Membrane with Underwater Superoleophobicity for High-Efficiency Oil-Water Separation, ACS Applied Materials & Interfaces, 2018, 10, 17301-17308; and Crick, C. R. et al., Superhydrophobic polymer-coated copper-mesh; membranes for highly efficient oil-water separation, Journal of Materials Chemistry A, 2013, 1, 5943-5948]. Targeting gravity-based separations, and not crossflow-based separations, for treating immense amounts of challenging oily feeds may not be able to handle the number of oily feeds.

There is a need to develop membranes using crossflow filtration systems where an oily wastewater stream can be fed to the membrane under applied feed pressure and the water may be separated and collected as permeate and the retentate can be further processed to dispose of or recover resources.

Although a few mixed matrix membranes have been developed in the past, there still exists a need to fabricate and explore more efficient filtration membranes for oil-water separation with cost-effectiveness, high stability, and improved separation efficiency, particularly when treating large feeds. Accordingly, an object of the present disclosure is to provide a mixed matrix membrane comprising reacted units of a 3,5-diaminobenzoic acid, an isophthaloyl chloride, and a polyvinylidene fluoride that may circumvent the drawbacks and limitations, such as selectivity, limited reusability, and environmental concerns, of the mixed matrix membranes already known in the art.

### SUMMARY

In an exemplary embodiment, a mixed matrix membrane is described. The mixed matrix membrane includes a polymer comprising reacted units of a 3,5-diaminobenzoic acid and an isophthaloyl chloride in a molar ratio of 5:1 to 1:5, and a polyvinylidene fluoride. A weight ratio of the polymer to the polyvinylidene fluoride is from 1:1 to 1:20, based on a total weight of the polymer and the polyvinylidene fluoride. The polymer and the polyvinylidene fluoride form a trilayer structure of horizontal layers with a first porous outer layer of the polyvinylidene fluoride and a second porous outer layer covering a porous inner layer of the polymer. The first porous outer layer has a pore size with a longest dimension of 3 to 30 μm, the second porous outer layer has a pore size with a longest dimension of 1 to 10 μm, and the porous inner layer has void spaces having an average longest dimension of from 20 to 500 μm. Amine groups and carboxyl groups in the polymer and fluorine in the polyvinylidene fluoride form hydrogen bonds between the horizontal layers.

In some embodiments, the reacted units of the 3,5-diaminobenzoic acid and the isophthaloyl chloride are connected by an amide bond.

In some embodiments, the membrane is porous and has an average pore size of 0.5 to 5 μm.

In some embodiments, the membrane has a thickness of 50 to 500 μm.

In some embodiments, the horizontal layers are denser at a top section of the membrane and a bottom section of the membrane than they are in a middle section of the membrane.

In some embodiments, the membrane comprises fluorine in an amount of 40 to 60 percent by weight (wt. %), carbon in an amount of 40 to 50 wt. %, nitrogen in an amount of 0.1 to 2 wt. %, and oxygen in an amount of 2 to 5 wt. % based on a total weight of the membrane.

In some embodiments, the membrane has a surface zeta potential of −1 to −15 mV.

In some embodiments, the membrane has a water contact angle of 45 to 65°.

In some embodiments, the membrane has an average surface roughness of 50 to 175 nm.

In some embodiments, the membrane has a squared average surface roughness of 60 to 250 nm.

In some embodiments, the membrane has an interfacial energy of 90 to 100 mJ/m².

In some embodiments, the membrane has a total organic carbon removal efficiency of 90 to 99% based on an initial amount of carbon in a sample.

In some embodiments, the membrane has a permeate flux of 2500 to 2700 L m² h⁻¹ bar⁻¹ for water.

In some embodiments, the polymer has a weight ratio of oxygen to nitrogen from 1:1 to 4:1.

In some embodiments, the polymer comprises carbon in an amount of 55 to 65 percent by weight (wt. %), nitrogen in an amount of 10 to 15 wt. %, and oxygen in an amount of 25 to 30 wt. % based on a total weight of the polymer.

In some embodiments, the polymer is in the shape of agglomerated flakes having a longest dimension of 5 to 50 μm.

In another embodiment, a process of making the polymer is described. The process includes dissolving 3,5-diaminobenzoic acid in dimethylacetamide to form a first solution, dissolving isophthaloyl in dimethylacetamide to form a second solution, chilling the first solution to a temperature of −10 to 10° C., mixing the first solution and the second solution for 2 to 4 hours at a temperature of −10 to 10° C. to form a reaction mixture, mixing the reaction mixture for 10 to 15 hours at a temperature of 15 to 35° C. to form the polymer in the reaction mixture, adding a chloride salt and a carbonate salt to the reaction mixture, isolating the polymer from the reaction mixture, and washing and drying the polymer.

In another embodiment, a method of filtration is described. The method includes flowing a mixture through the mixed matrix membrane. The mixture comprises one or more oils and water. The method further includes washing the membrane, flowing the mixture through the membrane, and collecting the permeate. The permeate has a lesser amount of the one or more oils than the mixture. The membrane has an oil-and-water separation rate of at least 90% of an initial oil-and-water separation rate.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flow chart depicting a method of preparing a polymer, according to certain embodiments.

FIG. 2A is a schematic illustration of fabrication of diallyl isophthalate-based (DAIP-based) polymer using 3,5-diaminobenzoic acid (DABA) and isophthaloyl chloride (IPC), according to certain embodiments.

FIG. 2B depicts an exemplary chemical reaction between DABA and IPC leading to formation of DAIP-based polymer, according to certain embodiments.

FIG. 3 is a schematic illustration of fabrication of a DAIP-based polymer decorated polyvinylidene fluoride membrane (a superhydrophilic mixed matric membrane), according to certain embodiments.

FIG. 4A is a protonated nuclear magnetic resonance (¹H-NMR) spectrum of the DAIP-based polymer in deuterated dimethyl sulfoxide (d₆-DMSO), according to certain embodiments.

FIG. 4B illustrates an enlarged segment of an ¹H-NMR spectrum of the DAIP-based polymer in d₆-DMSO, according to certain embodiments.

FIG. 5A is a scanning electron microscopy (SEM) image of the DAIP-based polymer, according to certain embodiments.

FIG. 5B is an enlarged view of an SEM image of the DAIP-based polymer, according to certain embodiments.

FIG. 5C is an elemental mapping analysis of the DAIP-based polymer, depicting the presence of carbon (C) in the DAIP-based polymer, according to certain embodiments.

FIG. 5D is an elemental mapping analysis of the DAIP-based polymer, depicting the presence of nitrogen (N) in the DAIP-based polymer, according to certain embodiments.

FIG. 5E is an elemental mapping analysis of the DAIP-based polymer, depicting the presence of oxygen (O) in the DAIP-based polymer, according to certain embodiments.

FIG. 5F is an energy dispersive X-ray (EDX) spectroscopy analysis for the DAIP-based polymer, according to certain embodiments.

FIG. 5G depicts a powder X-ray diffraction (XRD) pattern for the DAIP-based polymer, according to certain embodiments.

FIG. 5H is a Fourier-transform infrared (FTIR) spectrum of the DAIP-based polymer, according to certain embodiments.

FIG. 6A is a field emission transmission electron microscopy (FE-TEM) image of the DAIP-based polymer, with a scale of 500 nanometers (nm), according to certain embodiments.

FIG. 6B is an FE-TEM image of the DAIP-based polymer, with a scale of 50 nm, according to certain embodiments.

FIG. 6C is an FE-TEM image of the DAIP-based polymer, with a scale of 10 nm, according to certain embodiments.

FIG. 6D is a selected area electron diffraction (SAED) pattern of the DAIP-based polymer, according to certain embodiments.

FIG. 7A is an SEM micrograph of an M0 membrane (pristine, no DAIP-based polymer), according to certain embodiments.

FIG. 7B is an SEM micrograph of an M1 membrane (1 gram DAIP-based polymer), according to certain embodiments.

FIG. 7C is an SEM micrograph of an M2 membrane (2 g DAIP-based polymer), according to certain embodiments.

FIG. 7D is an SEM micrograph of an M3 membrane (3 g DAIP-based polymer), according to certain embodiments.

FIG. 8A is a cross-sectional SEM micrograph of the M0 membrane (also referred to as M0), according to certain embodiments.

FIG. 8B is a cross-sectional SEM micrograph of the M1 membrane (also referred to as M1), according to certain embodiments.

FIG. 8C is a cross-sectional SEM micrograph of the M2 membrane (also referred to as M2), according to certain embodiments.

FIG. 8D is a cross-sectional SEM micrograph of the M3 membrane (also referred to as M3), according to certain embodiments.

FIG. 9A is an ¹H-NMR spectrum of the DAIP-based polymer in d₆-DMSO, according to certain embodiments.

FIG. 9B is an enlarged segment of an ¹H-NMR spectrum of the DAIP-based polymer in d₆-DMSO, according to certain embodiments.

FIG. 9C is an ¹H-NMR spectrum of the M0 membrane in d₆-DMSO, according to certain embodiments.

FIG. 9D is an enlarged segment of an ¹H-NMR spectrum of the M0 membrane in d₆-DMSO, according to certain embodiments.

FIG. 9E is an ¹H-NMR spectrum of the M1 membrane in d₆-DMSO, according to certain embodiments.

FIG. 9F is an enlarged segment of an ¹H-NMR spectrum of the M1 membrane in d₆-DMSO, according to certain embodiments.

FIG. 9G is an ¹H-NMR spectrum of the M2 membrane in d₆-DMSO, according to certain embodiments.

FIG. 9H is an ¹H-NMR spectrum of the M3 membrane in d₆-DMSO, according to certain embodiments.

FIG. 9I is an enlarged segment of an ¹H-NMR spectrum of the M3 membrane in d₆-DMSO, according to certain embodiments.

FIG. 10A is an elemental mapping analysis of the M3 membrane, depicting the presence of fluorine (F) in the M3 membrane, according to certain embodiments.

FIG. 10B is an elemental mapping analysis of the M3 membrane, depicting the presence of carbon (C) in the M3 membrane, according to certain embodiments.

FIG. 10C is an elemental mapping analysis of the M3 membrane, depicting the presence of oxygen (O) in the M3 membrane, according to certain embodiments.

FIG. 10D is an elemental mapping analysis of the M3 membrane, depicting the presence of nitrogen (N) in the M3 membrane, according to certain embodiments.

FIG. 11A is an exemplary schematic illustration of chemical interactions between the DAIP-based polymer and PVDF, according to certain embodiments.

FIG. 11B depicts powder X-ray diffraction (XRD) patterns of the M0, M1, M2, and M3 membranes, according to certain embodiments.

FIG. 11C depicts an enlarged segment of powder XRD patterns of the M0, M1, M2, and M3 membranes, according to certain embodiments.

FIG. 11D depicts FTIR spectra of the M0, M1, M2, and M3 membranes, according to certain embodiments.

FIG. 11E depicts an enlarged segment of FTIR spectra of the M0, M1, M2, and M3 membranes, according to certain embodiments.

FIG. 12 is a graph depicting surface zeta potential of the M0, M1, M2, and M3 membranes, according to certain embodiments.

FIG. 13A depicts static water contact angle (WCA) measurements of the M0, M1, M2, and M3 membranes, according to certain embodiments.

FIG. 13B depicts dynamic WCA measurements of the M0, M1, M2, and M3 membranes, according to certain embodiments.

FIG. 14A is a three-dimensional (3D) topographical image of the M0 membrane, according to certain embodiments.

FIG. 14B is a 3D topographical image of the M1 membrane, according to certain embodiments.

FIG. 14C is a 3D topographical image of the M2 membrane, according to certain embodiments.

FIG. 14D is a 3D topographical image of the M3 membrane, according to certain embodiments.

FIG. 15A is a graph depicting interfacial free energies for the M0, M1, M2, and M3 membranes, according to certain embodiments.

FIG. 15B is a graph depicting surface energies for the M0, M1, M2, and M3 membranes, according to certain embodiments.

FIG. 15C is a graph depicting surface energy components for the M0, M1, M2, and M3 membranes, according to certain embodiments.

FIG. 15D is a graph depicting WCA versus surface energy of the M0, M1, M2, and M3 membranes, according to certain embodiments.

FIG. 16A is a graph depicting effect of transmembrane pressure on permeate flux of pure water for the M0, M1, M2, and M3 membranes, according to certain embodiments.

FIG. 16B is a graph depicting total organic carbon (TOC) in a feed and in permeates obtained during O/W separation for the M0, M1, M2, and M3 membranes, according to certain embodiments.

FIG. 17A depicts a stability test for fouling and cleaning cycles during O/W separation of the M0, M1, M2, and M3 membranes, according to certain embodiments.

FIG. 17B depicts TOC in permeates obtained during O/W separation for the M0, M1, M2, and M3 membranes, according to certain embodiments.

FIG. 17C is a microscopic image of a surfactant stabilized O/W emulsion feed and a resultant permeate obtained from the M3 membrane, according to certain embodiments.

FIG. 17D is an optical image depicting a feed sample including 148 parts per million (ppm) TOC and a permeate sample, including 7 ppm TOC, obtained from the M3 membrane, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “membrane” as used herein refers to a porous structure that is capable of separating components of a homogeneous or heterogeneous fluid. In particular, “pores” in the membrane indicate voids that allow fluid communication between different sides of a structure. As used herein, the term “pore” refers to an opening or space in a material, such as rock or solid, through which fluids or gases can pass. As used herein, the term “pore size” refers to the size of an opening, gap, and/or space in a material (i.e., a membrane, a layer, etc.). When a homogeneous or heterogeneous fluid is passed through the membrane, some components of the fluid can pass through the pores of the membrane into a “permeate stream,” some components of the fluid can be retained by the membrane and can thus accumulate in a “retentate,” and/or some components of the fluid can be rejected by the membrane into a “rejection stream.” Membranes can be of various thicknesses, with homogeneous or heterogeneous structures. Membranes can be in the form of flat sheets or bundles of hollow fibers. Membranes can also be in various configurations including, but not limited to, spiral wound, tubular, hollow fiber, a combination thereof, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to a superhydrophilic mixed matrix membrane (MMM) prepared by decorating a hydrophilic polyamide, a diallyl isophthalate-based (DAIP-based) polymer, in a polyvinylidene difluoride (PVDF) matrix for separation of a surfactant-stabilized oil/water (O/W) emulsion. The mixed matrix membrane (also referred to as “membrane”) of the present disclosure exhibits enhanced surface energy, hydrophilicity, and surface roughness with increasing DAIP-like content, and higher fouling resistance compared to pristine PVDF membrane, leading to improved O/W separation performance.

According to a first aspect of the present disclosure, a mixed matrix membrane or a membrane is described. The membrane includes a polymer including reacted units of a 3,5-diaminobenzoic acid (DABA) and isophthaloyl chloride (IPC) in a molar ratio of 5:1 to 1:5, preferably 4:1 to 1:4, preferably 3:1 to 1:3, preferably 2:1 to 1:2, and preferably about 1:1. In a preferred embodiment, the molar ratio of reacted units of the 3,5-diaminobenzoic acid and the isophthaloyl chloride in the polymer is about 1:1.

In some embodiments, the reacted units of the 3,5-diaminobenzoic acid and the isophthaloyl chloride are connected by an amide bond. The amide bond is formed via condensation polymerization between the 3,5-diaminobenzoic acid and the isophthaloyl chloride to form a diallyl isophthalate-based (DAIP-based) polymeric structure (polymer), that imparts properties onto the membrane. During the condensation, a hydrogen atom is lost from 3,5-diaminobenzoic acid and a chloride atom is lost from isophthaloyl chloride, which may generate hydrogen chloride as a byproduct.

The polymer may be in the form of a sphere, a rod, a cylinder, a rectangle, a triangle, a pentagon, a hexagon, a prism, a flower, a disk, a platelet, a flake, a cube, a cuboid, a cone, a pyramid, a wire, a ribbon, a block, a bead, a barrel, a foil, a star, a powder, an urchin, a combination thereof, and the like. In a preferred embodiment, the polymer is shape of agglomerated flakes having a longest dimension of 5 to 50 μm, preferably 10 to 45 μm, preferably 15 to 40 μm, preferably 20 to 35 μm, and preferably 25 to 30 μm.

In some embodiments, the polymer includes carbon in an amount of 55 to 65 percent by weight (wt. %), preferably 57 to 63 wt. %, more preferably 59 to 61 wt. %, and yet more preferably about 59.3 wt. %; nitrogen in an amount of 10 to 15 wt. %, preferably about 11 to 14 wt. %, more preferably 12 to 13 wt. %, and yet more preferably about 12.1 wt. %; and oxygen in an amount of 25 to 30 wt. %, preferably 26 to 29 wt. %, more preferably 27 to 29 wt. %, and yet more preferably about 28.6 wt. % based on a total weight of the polymer. In a specific embodiment, the polymer includes carbon in an amount of 59.3 wt. %, nitrogen in an amount of 12.1 wt. %, and O in an amount of 28.6 wt. % based on a total weight of the polymer.

In an embodiment, the polymer has a weight ratio of oxygen to nitrogen (O:N) from 1:1 to 4:1, preferably about 2:1 to 3:1, more preferably 2.2:1 to 2.6:1, and yet more preferably about 2.4:1.

The membrane also includes a polyvinylidene fluoride (PVDF) which provides structural support to the mixed matrix membrane. In some embodiments, other polymers including, but not limited to, polyolefins, fluoropolymers, polytetrafluoroethylene (PTFE), polystyrene (e.g., isotactic polystyrene and syndiotactic polystyrene), thermoplastic elastomers (TPE), silicones (e.g., polydimethylsiloxane (PDMS) and polymethylphenylsilicone (PMPS)), polyacetylenes (e.g., polytrimethylsilylpropyne), polysulfones (e.g., poly(1,4-phenylene ether-ether-sulfone), poly(1-hexadecene-sulfone), poly(1-tetradecene-sulfone), poly(oxy-1,4phenylenesulfonyl-1,4-phenylene), poly(oxy-1,4-phenylenesulfonyl-1,4-phenylene), poly(oxy-1,4-phenylenesulfonyl-1,4-phenylene), poly(oxy-1,4-phenylenesulfonyl-1,4-phenylene), and polyphenylsulfone), polysulfonamides (e.g., poly[1-[4-(3-carboxy-hydroxyphenylazo)benzenesulfonamido]-1,2-ethanediyl]), sulfonated polysulfones, polyethersulfones (PESs), sulfonated PESs, polyacetals, polyethers, polyetherimides, polyethylenimine, polystyrenes (including styrene-containing copolymers (e.g., acrylonitrilestyrene copolymers, styrene-butadiene copolymers, and styrene-vinylbenzylhalide copolymers)), polycarbonates, cellulosic polymers (e.g., cellulose acetate, cellulose triacetate, cellulose acetate-butyrate, cellulose propionate, ethyl cellulose, methyl cellulose, and nitrocellulose), polyamides (e.g., Nylon 6, polyphthalamide, aromatic polyamides, and aliphatic polyamides), polyimides, polyamide imides, polyketones, polyether ketones (e.g., polyether ether ketone and sulfonated polyether ether ketone), polyarylene oxide (e.g., polyphenylene oxide, polyxylene oxide, sulfonated polyxylene oxide, and brominated polyxylene oxide), polyesteramidediisocyanate, polyurethanes, polyurea, polyazomethines, polyesters (including polyarylates (e.g., polyethylene terephthalate and polyphenylene terephthalate)) polyalkyl methacrylate, polyacrylate, polysulfides, polyethylene, polypropylene, polybutene-1, poly(4-methyl pentene-1)), polyvinyls (e.g., polyvinyl chloride, polyvinyl fluoride, polyvinylidene chloride, polyvinylidene fluoride, polyvinyl alcohol, polyvinyl ester (e.g., polyvinyl acetate and polyvinyl propionate), polyvinyl pyridine, polyvinyl pyrrolidone, polyvinyl ether, polyvinyl ketone, polyvinyl aldehyde (e.g., polyvinyl formal and polyvinyl butyral), polyvinyl amide, polyvinyl amine, polyvinyl urethane, polyvinyl urea, polyvinyl phosphate, and polyvinyl sulfate), polyallyls, polybenzimidazoles, polyhydrazides, polyoxadiazoles, polytriazoles, polybenzimidazole, polycarbodiimides, polyphosphazines, microporous polymers, polycarbonates, polybenzoxazoles, copolymers (including block copolymers (e.g., polyether block amide, polyether esters, and polyetherimide-siloxane polymers)), containing repeating units of copolymers of acrylonitrile-vinyl bromide-sodium salt of para-sulfophenylmethallyl ethers, grafts, blends, a combination thereof, and the like may be used in place of or in combination with the PVDF.

In some embodiments, the membrane also includes a polyvinylpyrrolidone (PVP) which provides structural support to the mixed matrix membrane. In some embodiments, other polymers, including polymers made of monomers including lactams (i.e., α-lactam, β-lactam, δ-lactam, and ε-lactam) may be used in combination with or in place of the PVP.

In some embodiments, the polyvinylidene fluoride and the polyvinylpyrrolidone form a mixed polymer matrix (also referred to as matrix). In some embodiments, the polyvinylidene fluoride and the polyvinylpyrrolidone are alternating in the mixed polymer matrix.

The polymer and the PVDF form a trilayer structure of horizontal layers or a layered structure with a first porous outer layer of the polyvinylidene fluoride and a second porous outer layer of the polyvinylidene fluoride covering a porous inner layer of the polymer. In such a structural arrangement, the properties differ along the horizontal and vertical axes. In some embodiments, the horizontal layers are denser at a top section (the first porous outer layer) of the membrane and a bottom section (the second porous outer layer) of the membrane than they are in a middle section (porous inner layer of the polymer) of the membrane. The first porous outer layer has a pore size with a longest dimension of 3 to 30 μm, preferably 5 to 25 μm, preferably 7 to 20 μm, and preferably 10 to 15 μm. The second porous outer layer has a pore size with a longest dimension of 1 to 10 μm, preferably 2 to 8 μm, preferably 3 to 7 μm, and preferably 4 to 6 μm. The porous inner layer has void spaces having an average longest dimension of from 20 to 500 μm, preferably 50 to 400 μm, preferably 100 to 300 μm, and preferably 150 to 250 μm. In some embodiments, the middle section of the membrane has void spaces separated by vertical walls that connect the top section of the membrane and the bottom section of the membrane. In some embodiments, the void spaces in the middle section of the membrane have an average length of 20 to 500 μm, preferably 40 to 400 μm, preferably 60 to 300 μm, preferably 80 to 250 μm, and preferably 100 to 200 μm and a height of 20 to 200 μm, preferably 40 to 180 μm, preferably 60 to 160 μm, preferably 80 to 140 μm, and preferably 100 to 120 μm. In some embodiments, the top section of the membrane has a thickness of 20 to 100 μm, preferably 30 to 90 μm, preferably 40 to 80 μm, preferably 50 to 70 μm, and preferably 55 to 65 μm. In some embodiments, the bottom section of the membrane has a thickness of 1 to 50 μm, preferably 5 to 40 μm, preferably 10 to 30 μm, and preferably 15 to 25 μm.

The denser layers provide higher resistance to penetration, which is beneficial for mechanical stability and for preventing larger contaminants and/or particles from passing through the membrane (thereby preventing fouling), while the middle section which is less dense and allows for higher permeability and/or flow rates. This improves overall efficiency without compromising selectivity The variation in density across layers allows for selective transport of specific molecules, particles, and/or ions.

Interactions between the horizontal layers of the membrane are preferably non-covalent interactions. Amine groups and carboxyl groups in the polymer and fluorine in the polyvinylidene fluoride (PVDF) in the mixed polymer matrix form hydrogen bonds between the horizontal layers. In some embodiments, the amine groups and the carboxyl groups in the polymer form hydrogen bonds with other amine groups and carboxyl groups in the polymer in the horizontal layers of the top section of the membrane and the bottom section of the membrane.

A weight ratio of the polymer to the polyvinylidene fluoride is from 1:1 to 1:20, preferably 1:2 to 1:15, preferably 1:3 to 1:12, preferably 1:4 to 1:10, and preferably 1:5 to 1:9 based on the total weight of the polymer and the polyvinylidene fluoride.

In an embodiment, the membrane may be freestanding or supported on a substrate. Examples of materials from which the substrate can be made include, but are not limited to, ceramics, glass, metals, and polymers. In a preferred embodiment, the membrane is freestanding.

In some embodiments, the membrane has a thickness of 50-500 μm, preferably 55-450 μm, preferably 60-400 μm, preferably 65-350 μm, preferably 70-300 μm, preferably 75-250 μm, preferably 80-200 μm, preferably 85-150 μm, and preferably 90-100 μm.

In some embodiments, the membrane is porous. A porous material is the one that contains pores and forms a porous bulk solid. Pores may be isolated or are part of a network of pores (i.e., a plurality of interconnected pores). The pores of the membrane may have a regular shape, for example, a shape of a circle, an oval, or a polygon (e.g., triangle, rectangle, hexagon, rhombus, trapezium, parallelogram, pentagon, heptagon, octagon, nonagon, decagon, undecagon, and dodecagon). The polygon may be regular (i.e., all sides equal in length and all equal internal angles), convex (i.e., no internal angle is more than) 180°, or concave. In some embodiments, the pores may have an irregular shape in which each side has a different length and/or each side has a different curvature. Pores may be micropores, mesopores, macropores, and/or a combination thereof. The pores exist in the bulk material, not necessarily in the molecular structure of the material. The membrane may be macroporous, mesoporous, or microporous. The term “microporous” refers to pores in a membrane having an average pore width (i.e., diameter) of less than 2 nm. The term “mesoporous” refers to pores of a membrane having an average pore width of 2-50 nm. The term “microporous” refers to pores of membrane having an average pore width greater than 50 nm. In an embodiment, the membrane is porous and has an average pore size (i.e., diameter) of 0.5-5 μm, preferably 0.6-4.5 μm, preferably 0.7-4 μm, preferably 0.8-3.5 μm, preferably 0.9-3 μm, preferably 1-2.5 μm, and preferably 1.5-2 μm.

In some embodiments, the membrane has a surface roughness of 50-175 nm, preferably 55-170 nm, preferably 60-165 nm, preferably 65-160 nm, preferably 70-155 nm, preferably 75-150 nm, preferably 80-145 nm, preferably 85-140 nm, preferably 90-135 nm, preferably 95-130 nm, preferably 100-125, preferably 105-120, and preferably 110-115 nm. In a preferred embodiment, the membrane has a surface roughness of about 54 nm. In another preferred embodiment, the membrane has a surface roughness of about 165 nm. In yet another preferred embodiment, the membrane has a surface roughness of about 135 nm.

In some embodiments, the membrane a squared average surface roughness of 60-250 nm, preferably 65-245 nm, preferably 70-240 nm, preferably 75-235 nm, preferably 80-230 nm, preferably 85-225 nm, preferably 90-220 nm, preferably 95-215 nm, preferably 100-210 nm, preferably 105-205 nm, preferably 110-200 nm, preferably 115-195 nm, preferably 120-190 nm, preferably 125-185 nm, preferably 130-180 nm, preferably 135-175 nm, preferably 140-170 nm, preferably 145-165 nm, and preferably 150-160 nm. In a preferred embodiment, the membrane has a squared average surface roughness of about 67 nm. In another preferred embodiment, the membrane has a squared average surface roughness of about 234 nm. In yet another preferred embodiment, the membrane has a squared average surface roughness of about 193 nm.

In some embodiments, the membrane has a water contact angle (WCA) of 45 to 65°, preferably 47 to 63°, preferably 49 to 61°, preferably 51 to 59°, and preferably 53 to 57°. Generally, if a WCA of a material is less than 90°, the material is considered hydrophilic. If a WCA of a material is greater than 90°, the material is considered hydrophobic. In a preferred embodiment, the WCA of the membrane is about 51°. In another preferred embodiment, the WCA of the membrane is about 57°. In yet another preferred embodiment, the WCA of the membrane is about 61°.

In some embodiments, the membrane includes fluorine in an amount of 40 to 60 percent by weight (wt. %), preferably 42 to 59 wt. %, preferably 44 to 58 wt. %, more preferably 46 to 57 wt. %, and yet more preferably about 48 to 55 wt. %, carbon in an amount of 40 to 50 wt. %, preferably 41 to 49 wt. %, more preferably 41.5 to 48 wt. %, and yet more preferably 42 to 47 wt. %, oxygen in an amount of 2 to 5 wt. %, preferably 2.5 to 4.5 wt. %, and more preferably 2.8 to 4 wt. %, and nitrogen in an amount of 0.1 to 2 wt. %, preferably 0.2 to 1.8 wt. %, more preferably 0.4 to 1.6 wt. %, and yet more preferably 0.6 to 1.4 wt. % based on a total weight of the membrane. In a specific embodiment, the membrane includes about 48.3 wt. % fluorine, about 46.8 wt. % carbon, about 3.8 wt. % oxygen, and about 1.4 wt. % nitrogen. In another specific embodiment, the membrane includes about 54.2 wt. % fluorine, about 42.6 wt. % carbon, about 2.99 wt. % oxygen, and about 0.62 wt. % nitrogen. In yet another specific embodiment, the membrane includes about 52.8 wt. % fluorine, about 43.7 wt. % carbon, about 2.87 wt. % oxygen, and about 0.6 wt. % nitrogen.

In some embodiments, the membrane has a surface zeta potential of −1 to −15 mV, preferably −2 to −14 mV, and more preferably −3 to −12 mV at varying pH values.

In some embodiments, the membrane has an interfacial energy of 90 to 100 mJ/m⁻², preferably 92 to 99 mJ/m⁻², preferably 94 to 98 mJ/m², and preferably 95 to 97 mJ/m², which is higher than the pristine membrane (no DAIP-based polymer) (about 80 mJ m⁻²). The higher value is due to the presence of the hydrophilic component, DAIP-based polymer, in the membrane. In an embodiment, the membrane has a surface energy of 20 to 40 mJ/m², preferably 25-39 mJ/m², preferably 30-38 mJ/m², preferably 35-37 mJ/m², and more preferably about 37 mJ/m², which is much higher than the pristine membrane (no DAIP-based polymer) (about 20 mJ/m²). In an embodiment, the interfacial energy and the surface energy was found to increase with increase in concentration of DAIP percentage in the polymer.

In some embodiments, the membrane has a total organic carbon (TOC) removal efficiency of 90 to 99%, preferably 91 to 98%, preferably 92 to 97%, preferably 93 to 96%, and preferably 94 to 95% based on an initial amount of carbon in a sample. Total organic carbon (TOC) is one parameter used in the assessment of the water quality. It includes all carbon compounds as one mass, is defined, and is an absolute quantity; therefore, it may be determined directly. In membrane filtration, TOC is generally deposited on a feed side; however, this may cause membrane fouling and reduce the effectiveness of the membrane.

In some embodiments, the membrane has a permeate flux of about 2500 to 2700 L m² h⁻¹ bar⁻¹, preferably 2525 to 2675 L m² h⁻¹ bar⁻¹, preferably 2550 to 2650 L m² h⁻¹ bar⁻¹, more preferably 2575 to 2625 L m² h⁻¹ bar⁻¹, and yet more preferably about 2600 L m² h⁻¹ bar⁻¹ for pure water. Permeate flux is the amount of permeate or filtered liquid produced per unit of time and membrane area. It is typically measured in volume per square meter per hour. The flux rate may be dependent on the membrane type and operating conditions.

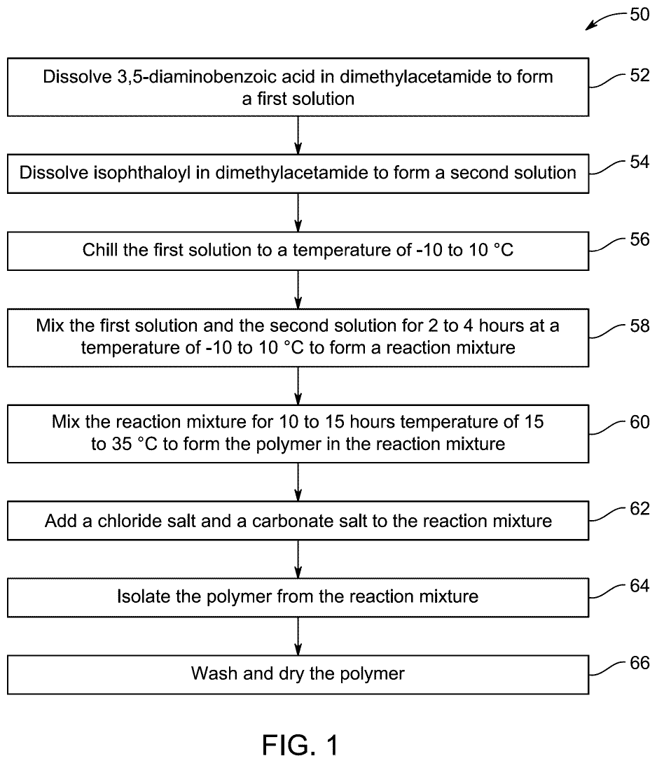

According to an aspect of the present disclosure, a method for making the polymer is described. Referring to FIG. 1, a schematic flow chart of a method 50 of making the membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes dissolving 3,5-diaminobenzoic acid (DABA) in dimethylacetamide to form a first solution. For this purpose, a defined amount of DABA is weighed and dissolved in dimethylacetamide, based on a desired concentration. In an embodiment, it is preferred to use high purity dimethylacetamide, preferably 95%, preferably 96%, preferably 97%, preferably 98%, and preferably 99%, to prevent impurities in it from affecting any unwanted reactions.

In some embodiments, other organic solvents, such as ethers (e.g., diethyl ether, tetrahydrofuran, 1,4-dioxane, tetrahydropyran, t-butyl methyl ether, cyclopentyl methyl ether, and di-iso-propyl ether), glycol ethers (e.g., 1,2-dimethoxyethane, diglyme, and triglyme), alcohols (e.g., methanol, ethanol, trifluoroethanol, n-propanol, iso-propanol, n-butanol, i-butanol, t-butanol, n-pentanol, i-pentanol, 2-methyl-2-butanol, 2-trifluoromethyl-2-propanol, 2,3-dimethyl-2-butanol, 3-pentanol, 3-methyl-3-pentanol, 2-methyl-3-pentanol, 2-methyl-2-pentanol, 2,3-dimethyl-3-pentanol, 3-ethyl-3-pentanol, 2-methyl-2-hexanol, 3-hexanol, cyclopropylmethanol, cyclopropanol, cyclobutanol, cyclopentanol, and cyclohexanol), aromatic solvents (e.g., benzene, o-xylene, m-xylene, p-xylene, mixtures of xylenes, toluene, mesitylene, anisole, 1,2-dimethoxybenzene, α,α,α-trifluoromethylbenzene, and fluorobenzene), chlorinated solvents (e.g., chlorobenzene, dichloromethane, 1,2-dichloroethane, 1,1-dichloroethane, and chloroform), ester solvents (e.g., ethyl acetate and propyl acetate), amide solvents (e.g., dimethylformamide, dimethylacetamide, N-methyl-2-pyrrolidone, formamide, N-formylmorpholine, N-methylformamide, 2-pyrrolidone, tetramethylurea, and N-vinylacetamide), urea solvents, ketones (e.g., acetone and butanone), acetonitrile, propionitrile, butyronitrile, benzonitrile, dimethyl sulfoxide, ethylene carbonate, propylene carbonate, 1,3-dimethyl-3,4,5,6-tetrahydro-2 (1H)-pyrimidinone, mixtures thereof, and the like may be used in place of or in combination with the dimethylacetamide. As used herein, a solvent may refer to non-polar solvents (e.g., hexane, benzene, toluene, diethyl ether, chloroform, and 1,4-dioxane), polar aprotic solvents (e.g., ethyl acetate, tetrahydrofuran, dichloromethane, acetone, acetonitrile, dimethylformamide, and dimethyl sulfoxide), polar protic solvents (e.g., acetic acid, n-butanol, isopropanol, n-propanol, ethanol, methanol, formic acid, and water), mixtures thereof, and the like may also be used in place of or in combination with the dimethylacetamide.

In an embodiment, a concentration of DABA in the first solution is in the range of 0.1-20 mM, preferably 1-15 mM, preferably 5-15 mM, and preferably 10-12 mM.

In some embodiments, the first solution may be slightly heated for complete dissolution of DABA in the first solution.

At step 54, the method 50 includes dissolving isophthaloyl chloride in dimethylacetamide to form a second solution. In an embodiment, a concentration of isophthaloyl chloride in the second solution is in the range of 0.1-20 mM, preferably 1-15 mM, preferably 5-15 mM, and preferably 10-12 mM. Other solvents may be used in place of or in combination with the dimethylacetamide.

At step 56, the method 50 includes chilling the first solution to a temperature of −10 to 10° C., preferably −8 to 8° C., preferably −5 to 5° C., preferably −3 to 3° C., more preferably −1 to 1° C., and yet more preferably about 0° C. Lower temperatures slow the reaction, allowing better control over polymerization. This minimizes side reactions and promotes high molecular weight polymer formation.

At step 58, the method 50 includes mixing the first solution and the second solution for 2 to 4 hours, preferably 2.5 to 3.5 hours, and preferably for 3 hours, at a temperature of −10 to 10° C., preferably −8 to 8° C., preferably −5 to 5° C., preferably −3 to 3° C., more preferably −1 to 1° C., and yet more preferably about 0° C., to form a reaction mixture. At low temperatures, the amines in DABA and acid chlorides in IPC react to form a polyamide in a controlled manner. This reaction results in the generation of hydrochloric acid (HCl) as a byproduct.

At step 60, the method 50 includes mixing the reaction mixture for 10 to 15 hours, preferably 11 to 14 hours, more preferably 12 to 13 hours, and yet more preferably about 12 hours at a temperature of 15 to 35° C., preferably 20 to 30° C., more preferably 23 to 27° C., and yet more preferably about 25° C. to form the polymer in the reaction mixture. The temperature is to promotes increased polymerization of reactants. The reaction time may promote the formation of a high molecular weight polymer.

At step 62, the method 50 includes adding a chloride salt and a carbonate salt to the reaction mixture. The chloride salt may include, but is not limited to, LiCl, NaCl, KCl, RbCl, CsCl, MgCl₂, CaCl₂), SrCl₂, BaCl₂, a combination thereof, and the like. In a preferred embodiment, the chloride salt is LiCl. The chloride salt may be added to precipitate the polymer. The carbonate salt may include, but is not limited to, Li₂CO₃, Na₂CO₃, K₂CO₃, Rb₂CO₃, Cs₂CO₃, MgCO₃, CaCO₃, SrCO₃, BaCO₃, a combination thereof, and the like. In a preferred embodiment, the carbonate salt is Li₂CO₃. The carbonate salt may be added to neutralize the HCl generated as a by-product in the reaction.

At step 64, the method 50 includes isolating the polymer from the reaction mixture. The polymer may be isolated by precipitating the polymer using water, methanol, ethanol, a combination thereof and the like. In a preferred embodiment, the polymer is isolate by precipitating the polymer with methanol. The precipitated polymer may be further filtered via centrifugation or other methods to obtain the polymer.

At step 66, the method 50 includes washing and drying the polymer. The polymer is washed to remove any residual salts, unreacted monomers, reaction intermediates, or byproducts. Drying ensures that the polymer is free from solvents and ready for use. In an embodiment, the polymer may be washed with water and/or methanol and dried, preferably using a freeze-dryer, and stored before use.

According to another aspect of the present disclosure, a method of filtration is described. The method includes flowing a mixture through the mixed matrix membrane (membrane). The mixture includes one or more oils and water. Suitable examples of oils include, but are not limited to, hexane, dodecane, crude oil, brackish water, heptane, octane, decane, nonane, cyclohexane, toluene, xylene, gasoline, kerosene, diesel, mineral oil, petroleum ether, light aromatic hydrocarbon, crude oil, lubricating oils, vegetable oils (e.g., canola oil, soybean oil, palm oil, peanut oil, safflower oil, avocado oil, sunflower oil, coconut oil, grapeseed oil, flaxseed oil, mustard oil, sesame oil, corn oil, and olive oil), diesel oil, a combination thereof, and the like. In one embodiment, the oil is diesel, and the mixture is stabilized by a surfactant, preferably a sodium dodecyl sulfate (SDS). In an embodiment, the concentration of diesel in the mixture is about 100 ppm. In some embodiments, water may be tap water, distilled water, bi-distilled water, deionized water, deionized distilled water, reverse osmosis water, hard water, fresh water, brine/salt water, a combination thereof, and the like. The hard water and the freshwater may include salts of sodium, magnesium, calcium, potassium, ammonium, iron, a combination thereof, and the like, and anions such as chloride, bicarbonate, carbonate, sulfate, sulfite, phosphate, iodide, nitrate, acetate, citrate, fluoride, nitrite, a combination thereof, and the like. The method includes collecting a permeate. The permeate has a lesser amount of the one or more oils than the mixture. The method of filtering involves a straightforward yet effective process in which the mixture is poured onto the membrane under atmospheric pressure. As the mixture passes through the membrane, the membrane acts as a barrier, allowing water and smaller solutes to permeate while retaining larger particles, contaminants, and/or oils. Separation occurs due to the membrane's pore structure and material properties, which may facilitate selective filtration. The resulting permeate is a clarified water solution, free from larger impurities, which is collected and is suitable for various applications, including reuse in industrial processes, environmental management, or even as pre-treated water for further purification methods.

In some embodiments, the permeate (also referred to as filtrate) may be collected through a crossflow filtration mode. In “crossflow” filtration, the feed solution flows tangentially across the membrane surface, creating a flow pattern that helps to minimize membrane fouling. The filtered liquid, or permeate, is collected through the membrane, while the remaining particles or larger substances are retained on the membrane surface or not able to permeate and cross the membrane.

As used herein, the term “surfactant” refers to a compound that lowers the surface tension (or interfacial tension) between two liquids, between a liquid and a gas, or between a liquid and a solid. A surfactant molecule includes one or more hydrophilic head units attached to one or more hydrophobic tails.

In some embodiments, the method includes washing the membrane prior to filtration. The purpose of washing the membrane, with a solvent, is to remove any particulates that may be present which might interfere with the membrane's functionality. The solvent is preferably water. The method further includes flowing the mixture through the membrane and collecting the permeate. The membrane has an oil-and-water separation rate of at least 90%, preferably at least 91%, preferably at least 92%, preferably at least 93%, preferably at least 94%, preferably at least 95%, preferably at least 96%, preferably at least 97%, preferably at least 98%, and preferably at least 99% of an initial oil-and-water separation rate.

### EXAMPLES

The following examples describe and demonstrate a mixed matrix membrane for treating oily wastewater. The examples are provided solely for illustration and are not to be construed as limitations of the present disclosure, as many variations thereof are possible without departing from the spirit and scope of the present disclosure.

### Example 1: Materials and Methodology

The precursors, 3,5-diaminobenzoic acid (DABA, 98%, Sigma-Aldrich) and isophthaloyl chloride (IPC, 99%, Sigma-Aldrich), were bought with high purity and used without further purification. N-methyl-2-pyrrolidone (NMP, 99%, Sigma-Aldrich) was used as a solvent. LiCl (99%), lithium carbonate (Li₂CO₃, 99%), and sodium dodecyl sulfate (SDS, 99%) were bought from Sigma-Aldrich. Methanol (98%) was obtained from Fisher Scientific. Diesel oil (100% purity) was obtained from Industrial and Mechanical Services Co. Ltd.

### Example 2: Synthesis of Hydrophilic Diallyl Isophthalate-Based or DAIP-Based Polymer

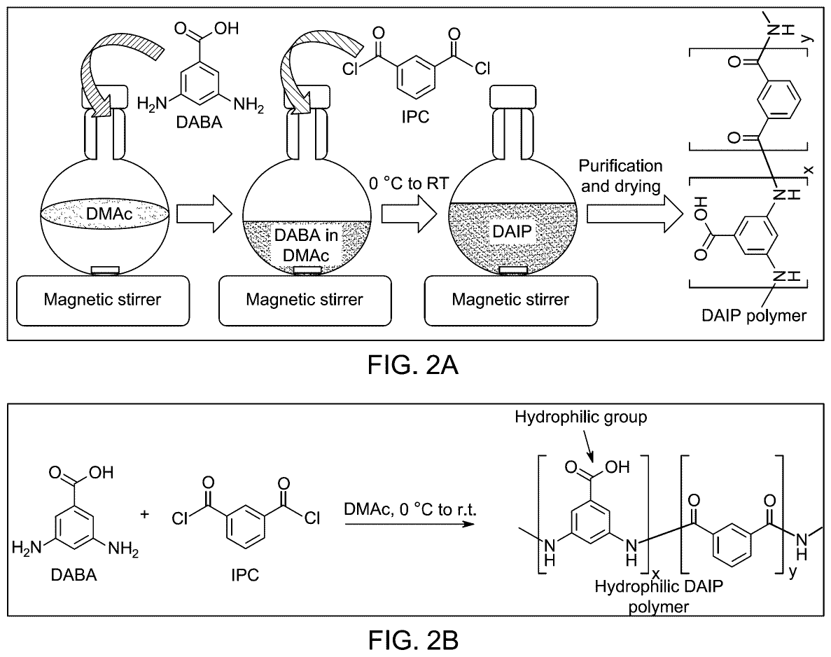

The polymer was synthesized using simple condensation polymerization between DABA and IPC. Initially, DABA was taken (2.0 g, 13.1 mmol) in a round bottom flask and allowed to dissolve completely in 30 mL of dimethylacetamide (DMAc). Then the solution was allowed to cool down to 0° C. using an ice bath. At the same time, IPC (2.7 g, 13.1 mmol) was dissolved in 10 mL of DMAc, and the IPC solution was added in a dropwise manner to the DABA solution resulting in the appearance of a greenish-grey colored viscous solution. The reaction was allowed to proceed at 0° C. for 3 h and then moved to room temperature where it was allowed to stir for 12 h. 1 g of LiCl salt was added to enhance the dissolution of the newly formed polymer. 2 g of Li₂CO₃ was then added to the reaction mixture which resulted in the quenching of any hydrochloric acid generated during the reaction. Finally, the polymer was added to an excess of methanol and white precipitates were obtained. The precipitates were collected and washed with methanol and water to remove the unreacted monomers and salts of Li. Eventually, the polymer was dried using a freeze-dryer and stored for further use. FIG. 2A and FIG. 2B depict reaction intermediates, products, and steps of the reaction between DABA and IPC.

### Example 3: Fabrication of DAIP-PVDF (Polyvinylidene Difluoride) Membranes

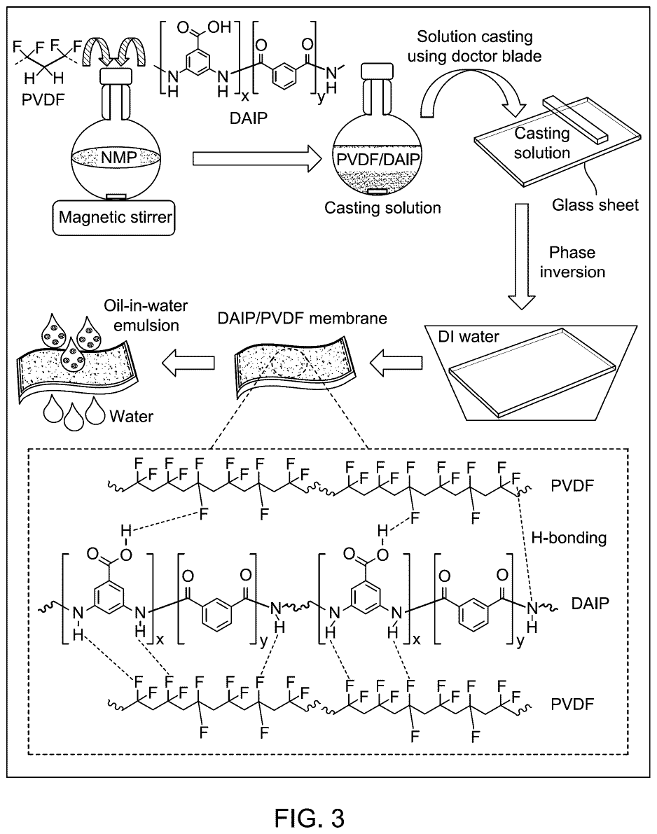

The membranes were fabricated using non-solvent-induced phase separation (NIPS) [Younas, H. et al., Fabrication of high flux and fouling resistant membrane: A unique hydrophilic blend of polyvinylidene fluoride/polyethylene glycol/polymethyl methacrylate, Polymer, 2019, 179, 121593, which is incorporated herein by reference in its entirety]. For preparing a polyvinylidene fluoride (PVDF)-dope solution, 8.0 g of PVDF and 3.0 g of polyvinylpyrrolidone (PVP) were dissolved in 89.0 g of NMP. Similarly, 3 other dope solutions were prepared by dissolving the same amounts of PVDF (8.0 g) and PVP (3.0 g) while different amounts (1.0, 2.0, and 3.0 g) of the DAIP-based polymer were added and the mass of NMP was adjusted to 88.0 g, 87.0 g, and 86.0 g, respectively, for a total of 100.0 g. Each of the solutions were allowed to stir at 60° C. for 8 h resulting in the formation of a clear dope solution which was kept at room temperature to allow any entrapped air bubbles to escape. The bubble-free dope solutions were cast by using a casting knife (250 μm slit size). The polymer dope solution was cast on a tempered glass surface and immediately dipped in a de-ionized (DI) water bath leading to coagulation of the polymer which resulted in the formation of a free-standing membrane. In total four membranes were fabricated including a control membrane, M0. The other three membranes were regarded as M1, M2, and M3 which corresponded to the amount of DAIP-based polymer that was included in the dope solutions, 1.0 g, 2.0 g, and 3.0 g, respectively. The membranes were left in DI water overnight and then tested for separating oil-in-water (O/W) emulsions using a crossflow filtration system. For the sake of characterization, the membranes were dried before any analysis. The steps involved in the fabrication of the DAIP-decorated/PVDF membranes are depicted in the FIG. 3

### Example 4: Characterization of the DAIP Fabricated Membranes

The DAIP-based polymer and membranes were characterized by several membrane characterization techniques, including nuclear magnetic resonance (NMR) spectroscopy where the cast membranes were dried and dissolved in d₆-DMSO and samples were run on NMR (600 Hz, JEOL) and attenuated total reflectance Fourier-transform infrared (ATR-FTIR, Nicolet iS50 FT-IR) spectroscopy was carried out by exposing the dried membrane to the laser beam in ATR mode and spectra were recorded for the polymer and each membrane, including the control. Scanning electron microscopy (SEM, EM-30AX, COXEM) analysis was carried out by taking a small piece of each membrane which was gold coated for 110 seconds for 10 milliamperes. Energy dispersive X-ray (EDX) and mapping analysis was performed using an inbuilt OXFORD elemental analyzer. Surface roughness of the membranes was determined using atomic force microscopy (AFM) where a small piece of each membrane was cut and affixed to a glass slide. Surface roughness was measured by measuring the amplitude of the cantilever motion. Surface energy and surface wettability of the membranes were determined by the extended Derjaguin-Landau-Verway-Overbeek (XDLVO) method via a contact angle (CA) measurement method using goniometer (DSA25S, KRUSS, Germany).

### Example 5: Oil/Water (O/W) Separation Performance of the Membranes

Oil/water (O/W) separation performances of the membranes was carried out using a crossflow filtration system (BNGH2978 Membrane Unit, Shandong Bona Biotechnology Group CO., Ltd China) where the membranes were installed in a parallel manner and fed with feeds of DI water and an oil-in-water emulsion. The membranes were initially compacted using DI water as feed until a steady water flow was achieved. The membranes were then contacted with an O/W emulsion as a feed (100 ppm of diesel oil in water stabilized by 0.01 g of SDS). The separation efficiency of the membranes was then evaluated. Pure water flux was measured using the following set of equations:

$$J = \frac{V}{A \times t} \qquad ( 1 )$$

where “J” is the pure water flux (L m⁻² h⁻¹), “V” (L) is the volume of the permeate collected in a given time, “A” (m²) is the effective area of the membrane, and “t” (h) is the time required for collecting a specific volume of the permeate.

$$Seperation efficiency ( \% ) = \frac{( {c}_{i} - {c}_{f} )}{{c}_{i}} \times 100 \qquad ( 2 )$$

where “Cᵢ” is the initial oil concentration, “C_{f}” is the final concentration of the oil in the emulsion. The oil concentration in the feed and permeate was measured using total organic carbon (TOC) analyzer (Shimadzu TOC-L CSH, Japan).

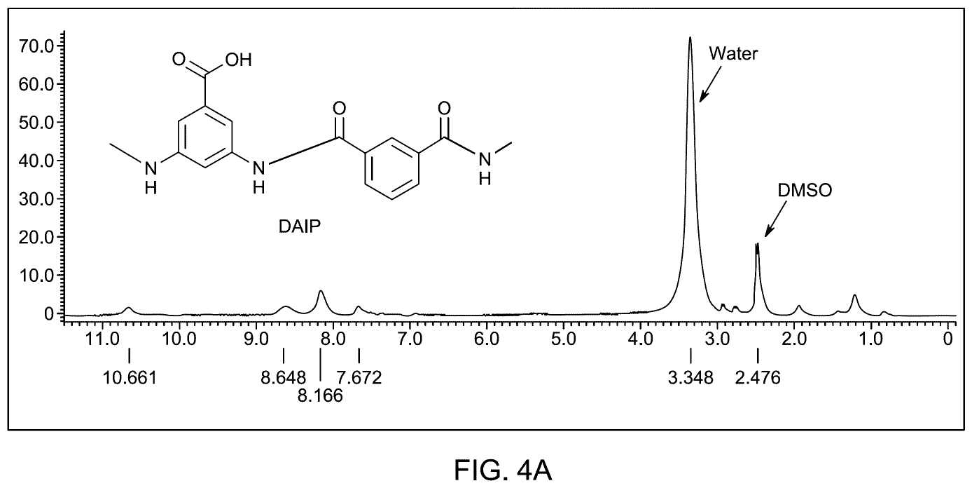

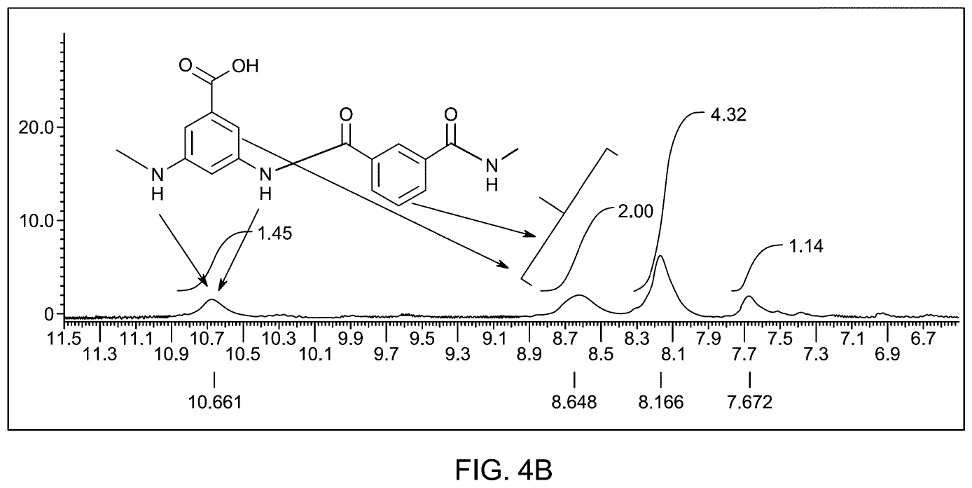

Physical and chemical features of the DAIP-based polymer and the membranes (M0, M1, M2, and M3) were determined to understand the performance of the membranes. The structure of the DAIP-based polymer was confirmed by several characterization techniques, including ¹H-NMR, SEM, EDX, FE-TEM, and XRD. ¹H-NMR showed the presence of the characteristic peaks of the DAIP-based polymer in the aromatic region of the spectrum (FIG. 4A). The peak at 10.7 ppm corresponds to the amide (—CONH) of the polyamide, the doublet at 8.6 ppm corresponds to each proton (on benzene rings) between the two amide bonds of DABA and IPC, the quartet at 8.2 ppm corresponds to 2 protons ortho to the amide bonds on each benzene ring while the remaining singlet proton at 7.7 ppm is due to the —CH of the IPC ring. Broadening of the proton NMR peak confirms the polymeric nature of the DAIP-based polymer. FIG. 4B shows the expansion of the aromatic region of the full-scale spectrum of the DAIP-based polymer.

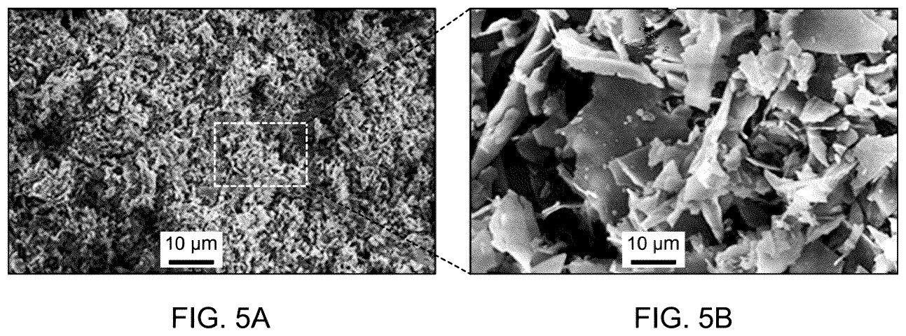

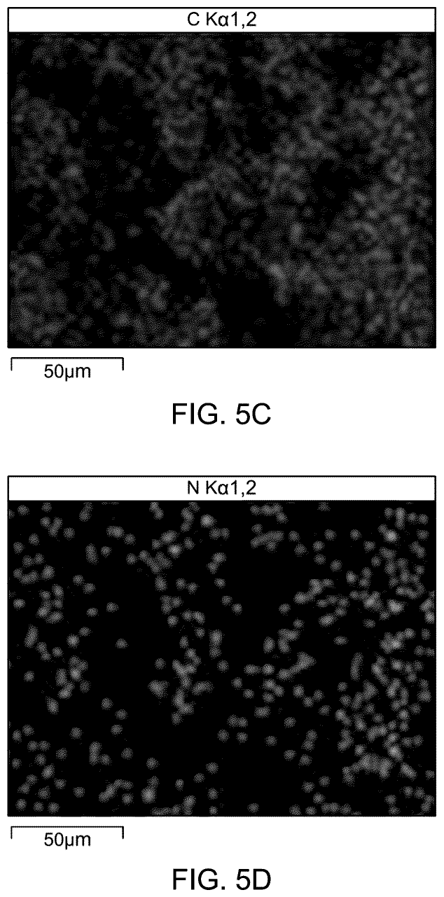

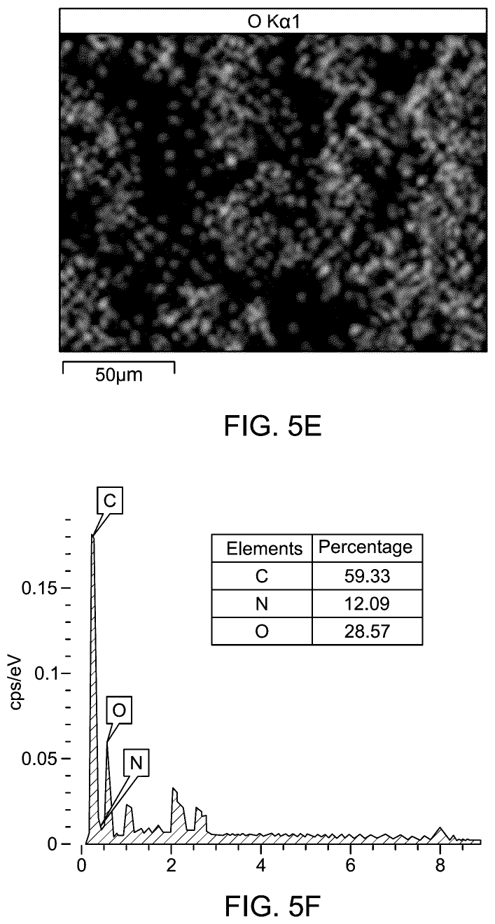

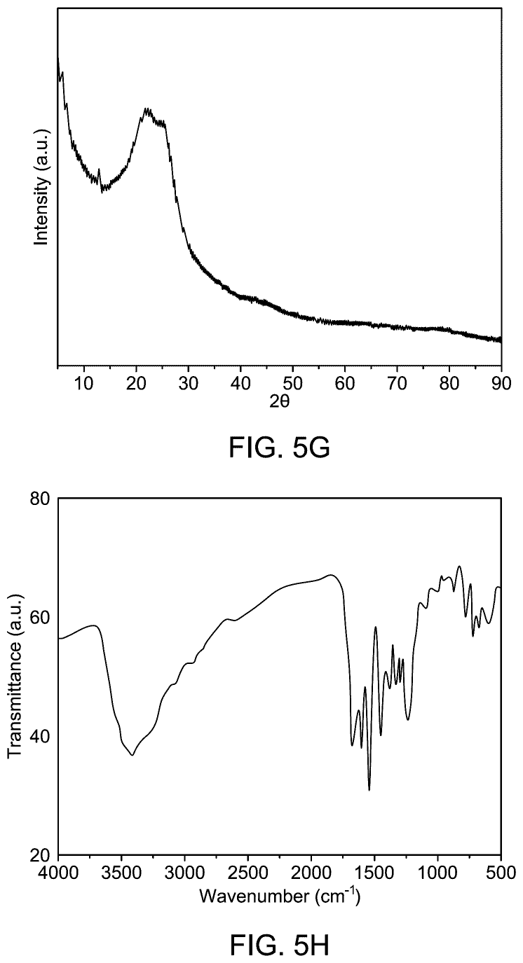

SEM micrographs of the DAIP-based polymer show a flake-like appearance of the polymer (FIG. 5A and FIG. 5B). The polymer was physically fluffy which is attributed to the sheet-like flakes of the DAIP-based polymer. Elemental mapping and EDX analysis revealed that the constituent elements carbon (C), nitrogen (N), and oxygen (O) were detected and found to be uniformly distributed throughout the structure of the polymer (FIGS. 5C-5E). EDX analysis showed the following percentages of the identified elements: C (59.3%), N (12.1%), and O (28.6%) where the percentage of O is higher than that of N. Ideally, each amide linkage (—CONH) has an O to N ratio of 1; however, in the case of the DAIP-based polymer this ratio of O:N is about 2.4 (FIG. 5F). This higher ratio of O to N can be attributed to the presence of two additional oxygen atoms in the form of a carboxylic acid functional group (—COOH) per repeating unit of the DAIP-based polymer because a —COOH group is present in the DABA molecule. Powder XRD of DAIP-based polymer showed an amorphous structure with two broad diffraction peaks located at a 20 of 20° and 26° (FIG. 5G) which can be attributed to near-ordered regions in the amorphous mass of the DAIP-based polymer owing to extensive hydrogen bonding between the chains of the DAIP-based polymer since the DAIP-based polymer has several hydrogen bond donor and acceptor groups. The presence of these functionalities in the DAIP-based polymer (also referred to as a DAIP-based structure) was confirmed by FTIR analysis, as shown in FIG. 5H. The DAIP-based polymer contains different functional groups such as benzene, —COOH, and —CONH linkages. A broad peak with a sharp tip spanning from 3800 cm⁻¹ to 3400 cm⁻¹ confirms the —OH stretching vibration of —COOH groups overlapped with —NH stretching of —CONH. The other peak located at 3000 cm⁻¹ is attributed to the aromatic —CH stretching vibrations of the DAIP-based polymer. Two more peaks located in the lower wavenumber range with signals at 1700 cm⁻¹ and 1650 cm⁻¹ were attributed to carbonyl (>C—O) stretching vibrations of —COOH and —CONH bonds, respectively. Another characteristic peak confirming the —CONH bond formation was the —NH bending vibrations observed at 1500 cm⁻¹. Identification of peaks in the FTIR spectrum confirmed the formation of the polyamide, the DAIP-based polymer, through a polycondensation reaction between DABA and IPC having highly hydrophilic-COOH groups decorated at the polymer backbone.

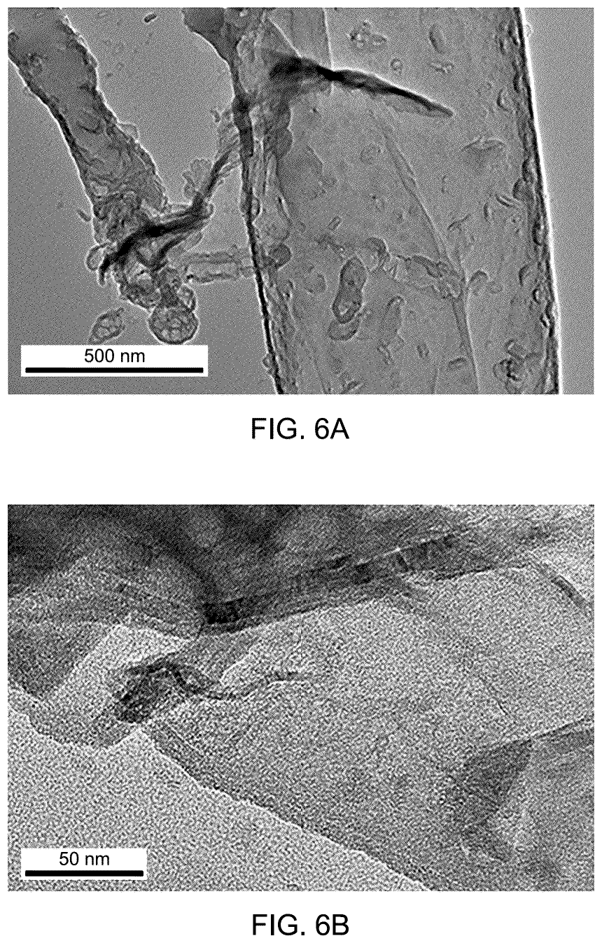

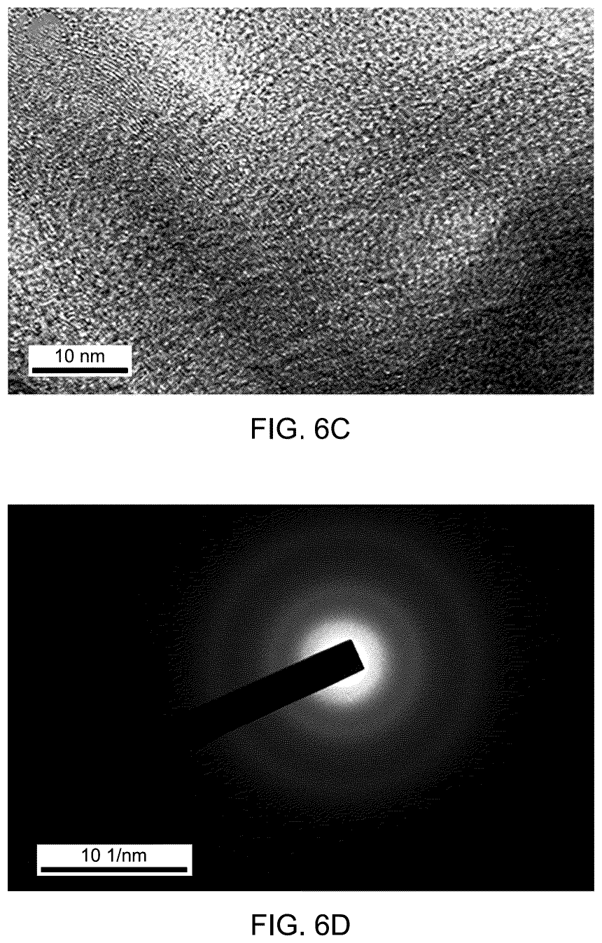

Field emission transmission electron microscopy (FE-TEM) analysis of the DAIP-based polymer showed a sheet-like lamellar structure (FIG. 6A). The glassy appearance of the DAIP-based sheets can be seen stacked on one another in FIG. 6B. The lamellar sheets also confirm the polymeric nature of the DAIP-based polymer. High-resolution images show that the DAIP-based polymer is also porous in nature (FIG. 6C). The selected area electron diffraction (SAED) pattern of the DAIP-based polymer revealed the amorphous structure (FIG. 6D). Although the SAED rings are fused, unlike crystalline polymers, two slightly distinct rings can be observed which matches with the XRD pattern observed for the DAIP-based polymer. The DAIP-based polymer has slightly ordered areas dispersed in the amorphous bulk of the DAIP-based polymer. Features like being porous, lamellar, and amorphous contribute to the oil/water separation characteristics of the membranes.

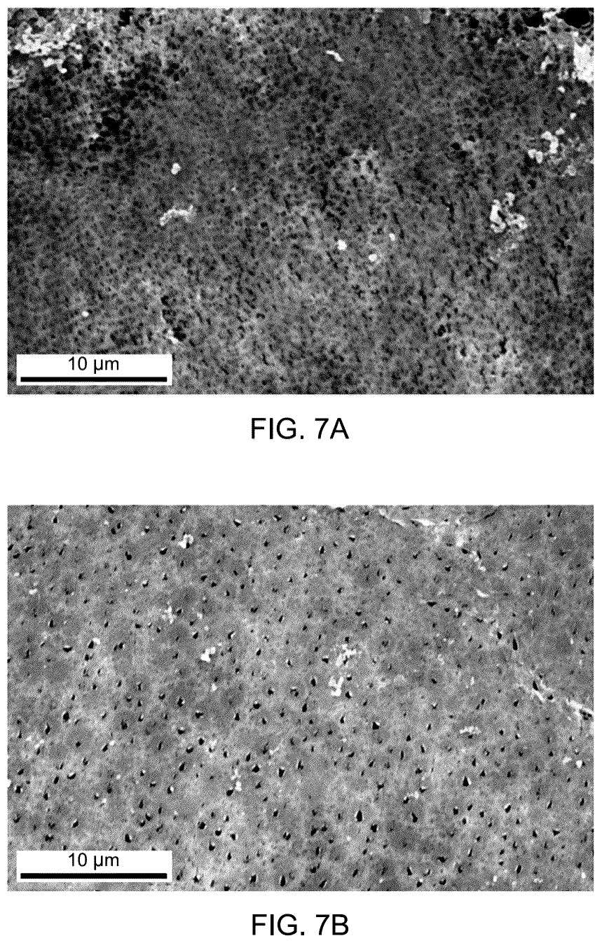

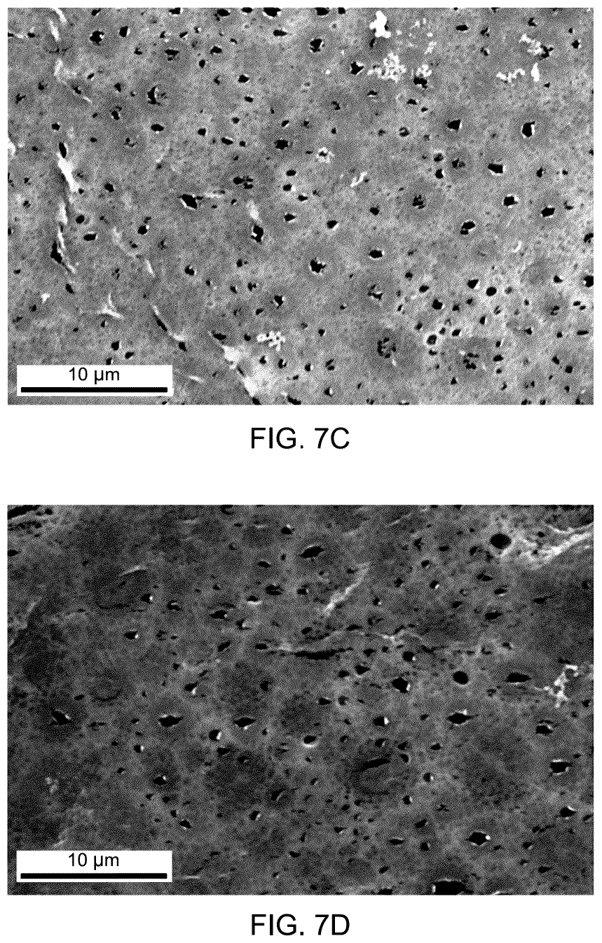

Surface SEM analysis of the membranes was performed to determine surface morphology. FIG. 7A shows that the PVDF membrane (i.e., the control) has a uniform conformation of having a lower-grade ridge and valley morphology owing to the wet phase inversion of the membrane. Pore size of the top layer of the membranes increased with increasing percentage of the DAIP-based polymer. Surface texture of the DAIP-based polymer decorated membranes was also altered compared to the control membrane. This indicates that the DAIP-based polymer is responsive to the phase inversion process and undergoes a solidification along with PVDF. The hydrophilic nature of the DAIP-based polymer allows more water to penetrate the matrix during phase inversion which results in pore broadening, as seen in FIGS. 7B-7D). Due to the hydrophilic nature of the DAIP-based polymer, there is a chance that the DAIP-based polymer will be exposed to an outer environment of the matrix and/or membrane and lie more towards the surface and pore walls. On the other hand, the DAIP-based polymer has a hydrophobic backbone composed of benzene rings which may develop homogeneity with the PVDF matrix and lead to uniform impregnation throughout the membrane structure. The effect of the DAIP-based polymer is equally evident over the entire area of the membrane which leads to a reduction in the creation of defects in the membrane structure and leads to good performance during filtration.

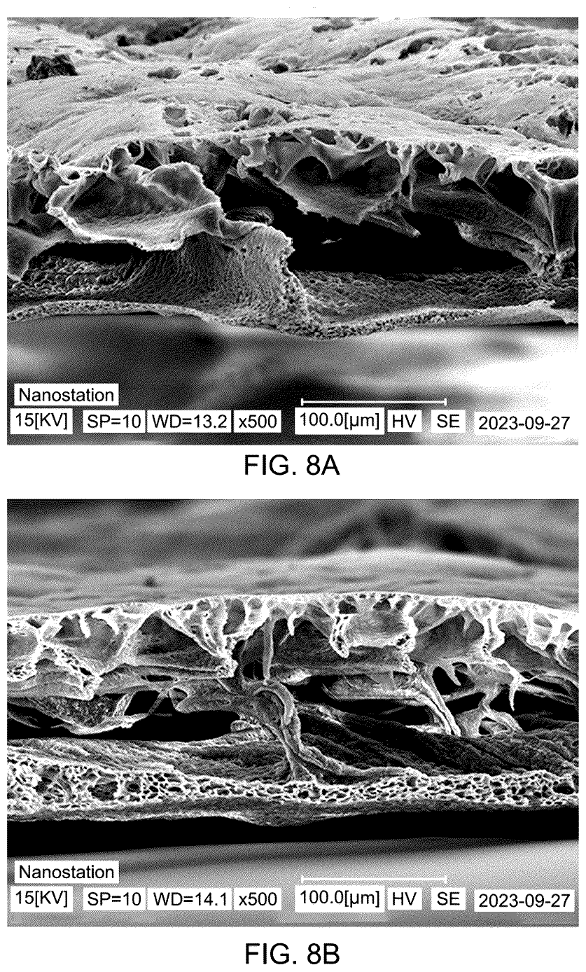

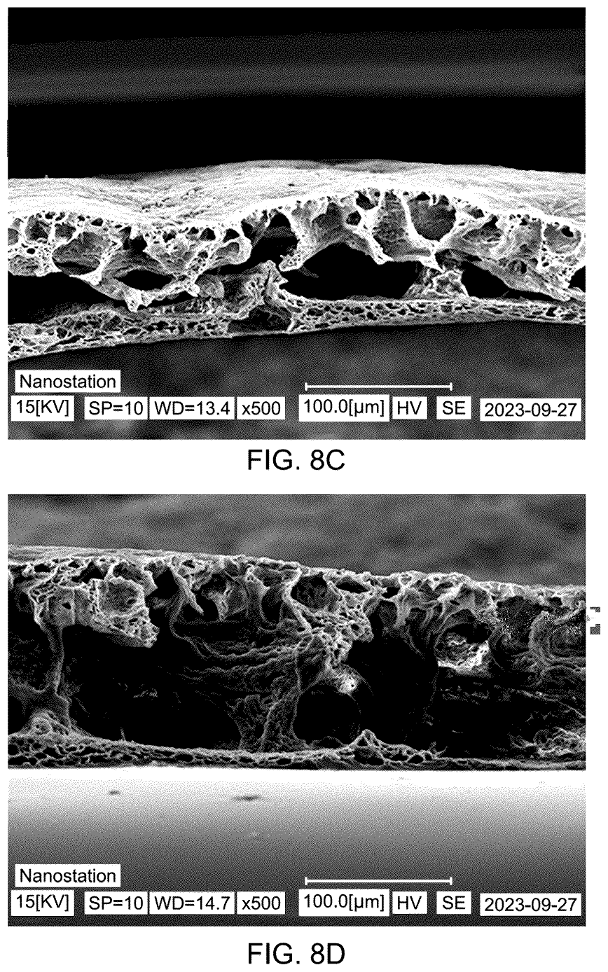

Cross-sectional SEM micrographs reveal the thickness variations and the asymmetric nature of the membranes. These features may determine performance of the membranes during filtration. FIG. 8A is a cross-sectional SEM analysis of the PVDF membrane which reveals a PVDF bilayer separated by a polymeric matrix with large channels. The top and bottom layers are dense compared to the inner matrix which can serve as an advantage because the top layers with narrow pores can lead to the separation of the oil from water during separation experiments. As seen in the surface SEM analysis of the membranes (FIGS. 7B-7D), pore sizes increase by increasing the amount of the DAIP-based polymer, and the same effect can be seen in the cross-sectional SEM micrographs as well (FIGS. 8B-8D). The pores in the bottom layer become bigger with the increasing dosage of the DAIP-based polymer. Another feature that can be observed from the cross-sectional SEM micrographs is the increase in the bulkiness and density of the matrix of the membranes with increasing DAIP-based polymer concentration in the membrane structure. This confirms the contribution of the DAIP-based polymer concentration in the structure of the membranes.

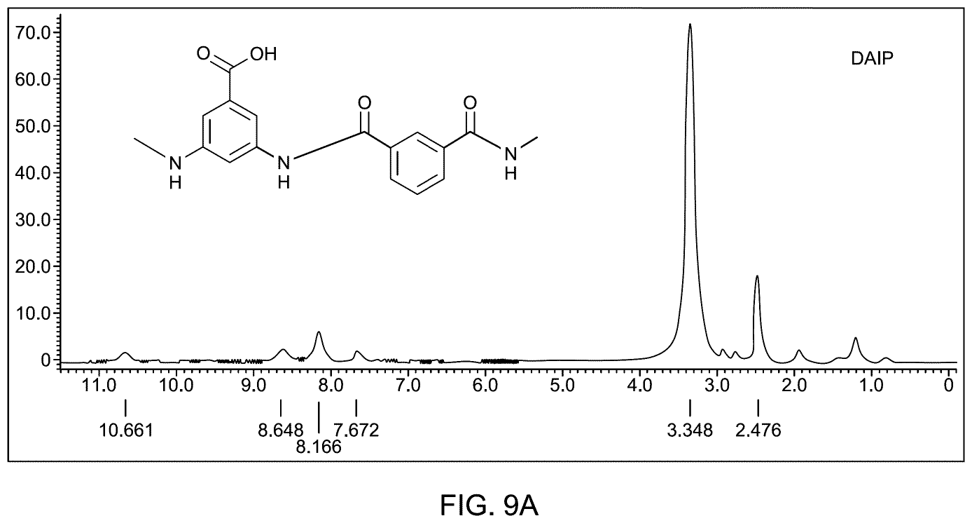

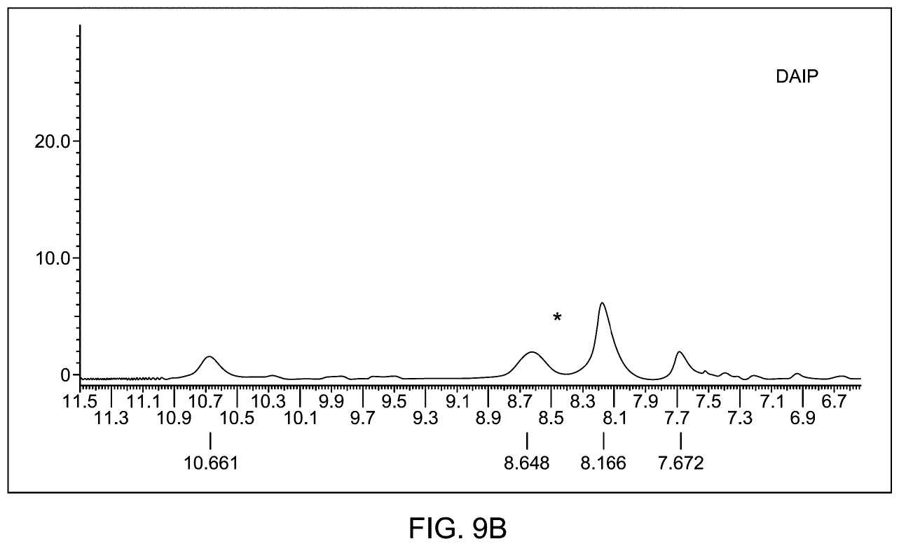

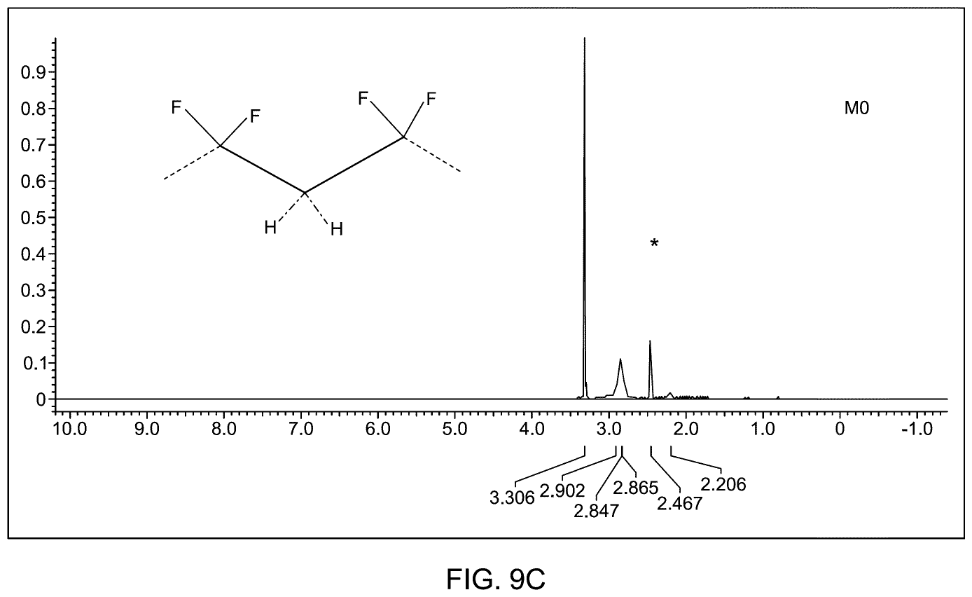

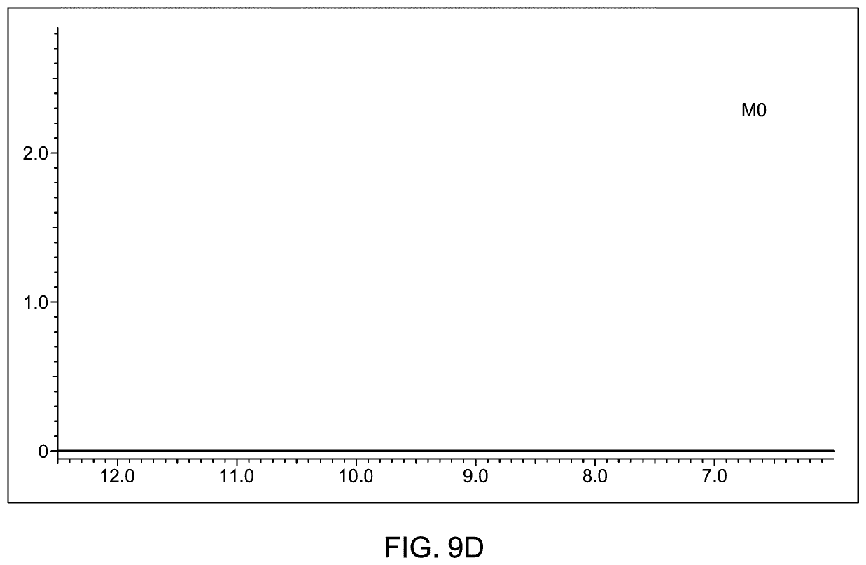

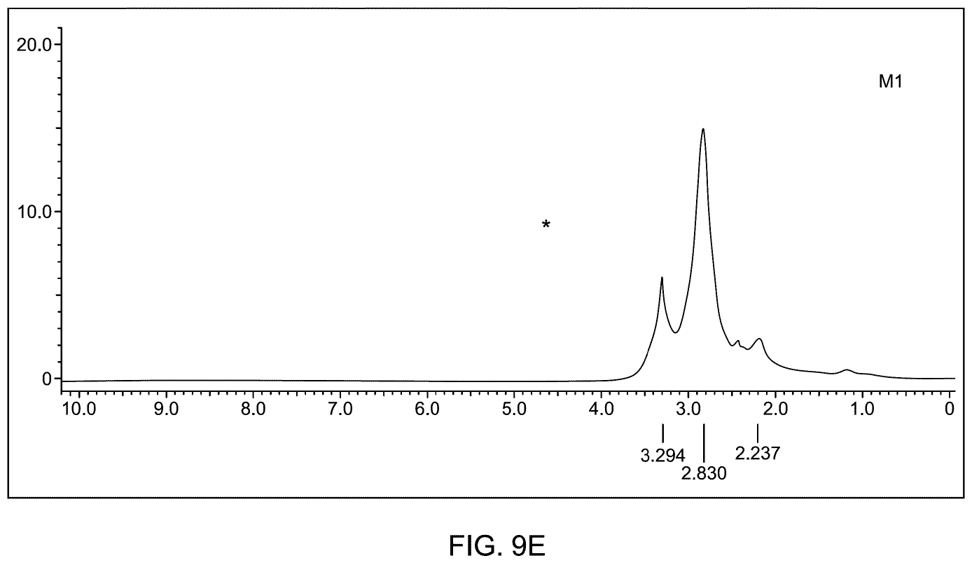

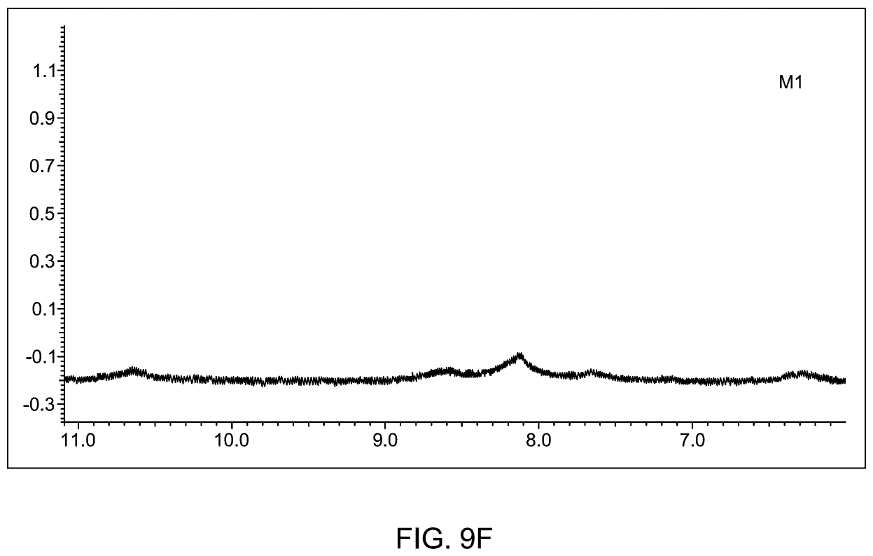

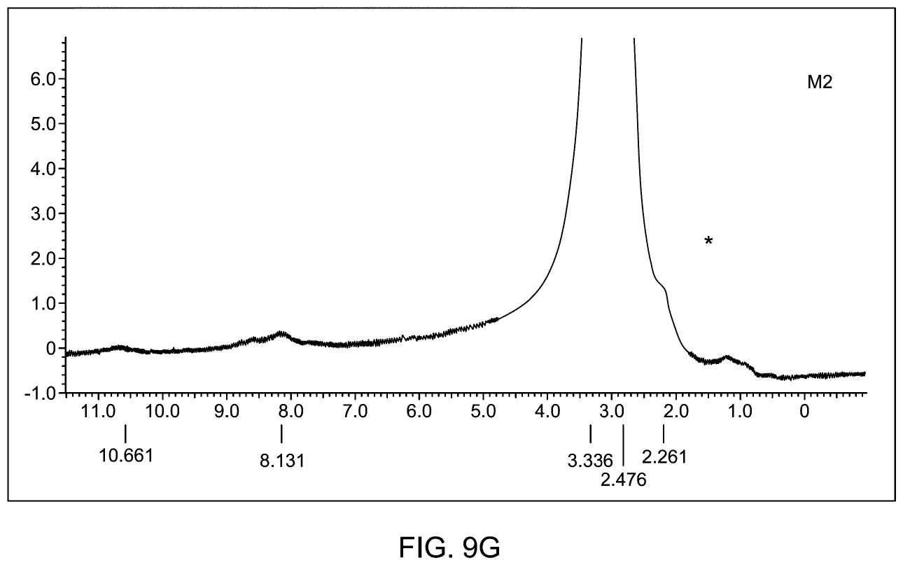

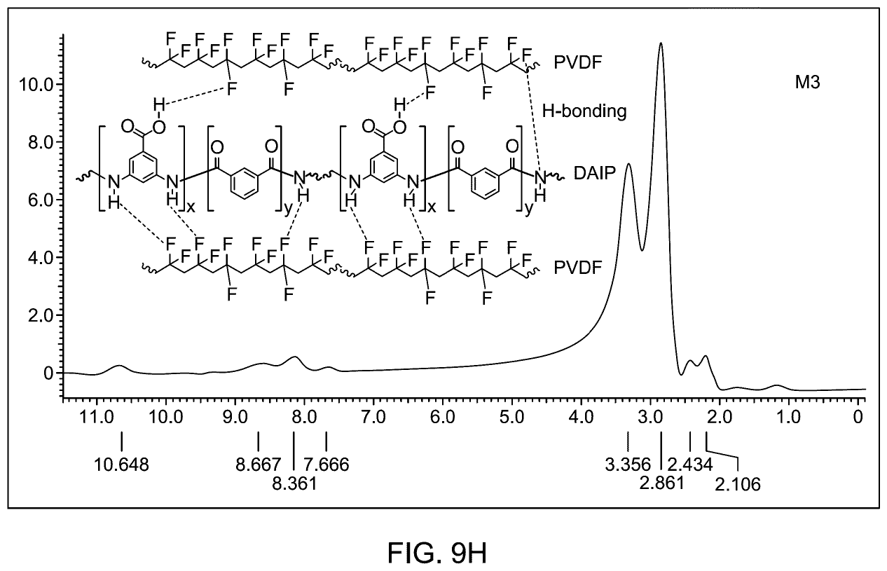

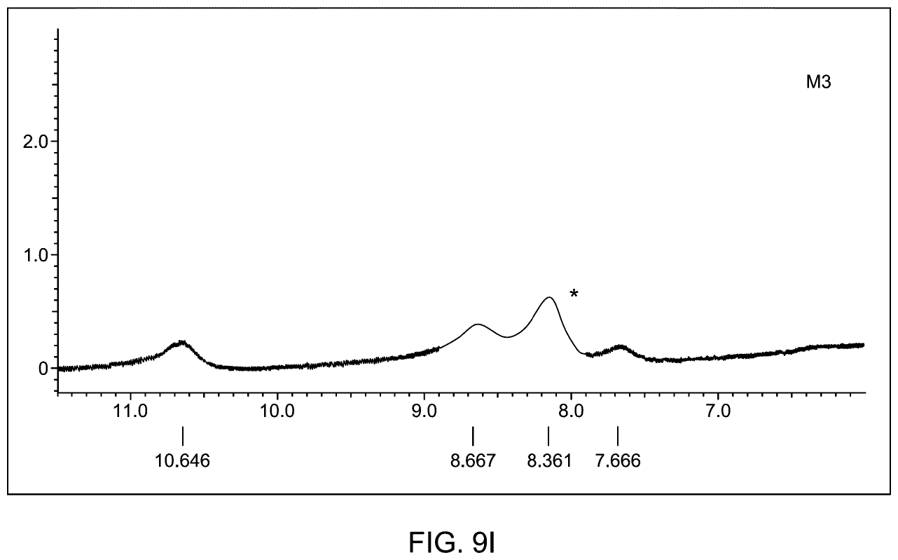

Further confirmatory evidence of the contribution and existence of the DAIP-based polymer in the membrane structure and chemistry was gathered through ¹H-NMR analysis of the fabricated membranes. The DAIP-based polymer displays peaks in an ¹H-NMR spectrum, which are also shown in FIG. 9A and FIG. 9B for comparison with the control M0. M0 is a control membrane composed of PVDF; therefore, the ¹H-NMR spectrum of M0 has characteristic peaks of aliphatic head-to-tail —CF₂—CH₂—CF₂—CH₂— located at 2.85 ppm. Another small peak at 2.2 ppm is attributed to the head-to-head (—CF₂—CH₂—CH₂—CF₂—) monomer reaction during the growth of PDVF polymer (FIG. 9C) [Xia, W. and Zhang, Z., PVDF-based dielectric polymers and their applications in electronic materials, IET Nanodielectrics, 2018, 1, 17-31, which is incorporated herein by reference in its entirety]. The PVDF membrane does not possess any aromatic peaks in the spectrum (FIG. 9D). For the DAIP-containing PVDF membranes (M1, M2, and M3), peaks appear in the aromatic region corresponding to the concentration of the DAIP-based polymer used in membrane fabrication. In the case of M1 (FIGS. 9E-9F), in addition to PVDF peaks, small peaks of the DAIP-based polymer can be seen in the zoomed aromatic region (FIG. 9F) of the ¹H-NMR spectrum. The intensity of the peaks increasing corresponds to an increase in the DAIP-based polymer concentration from M1 to M2 (FIG. 9G) and M3 (FIGS. 9H-9I). In the case of M3, the DAIP-based peaks are marked and visible (FIG. 9I). ¹H-NMR analyses of the membranes upon phase inversion confirmed the existence of the DAIP-based polymer in the membrane matrix.

EDX analysis was performed to understand the chemical composition of the membranes. Table 1 shows that the control PVDF membrane was composed of solely fluorine (F) and carbon (C), owing to its chemical composition. M1, M2, and M3 contain additional elements of oxygen (O) and nitrogen (N). The presence of O and N in M1, M2, and M3 membranes is attributed to the —COOH and amide (—CONH) functional groups in the DAIP-based polymer. EDX analysis confirms the decoration of the DAIP-based polymer in the PVDF membrane structure.

TABLE 1
EDX analysis of control M0 and DAIP
decorated M1, M2 and M3 membranes

| Membrane | F | C | O | N |
|---|---|---|---|---|
| M0 | 54.1 | 45.9 | — | — |
| M1 | 54.2 | 42.6 | 2.99 | 0.62 |
| M2 | 52.8 | 43.7 | 2.87 | 0.6 |
| M3 | 48.3 | 46.8 | 3.8 | 1.4 |

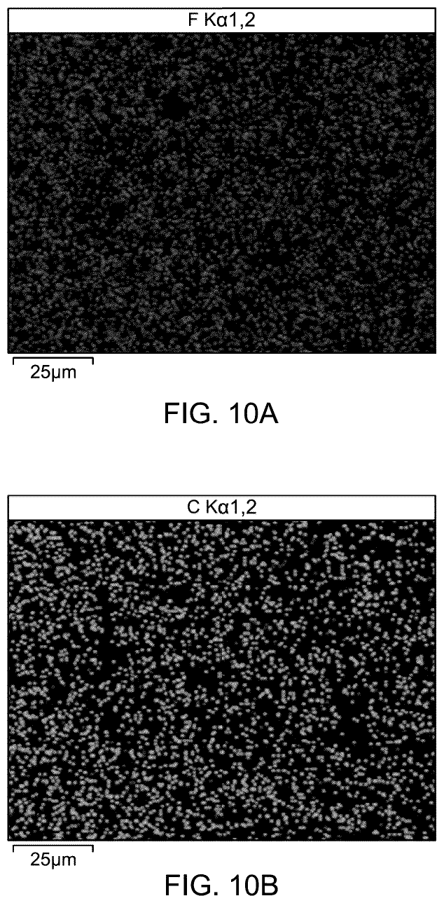

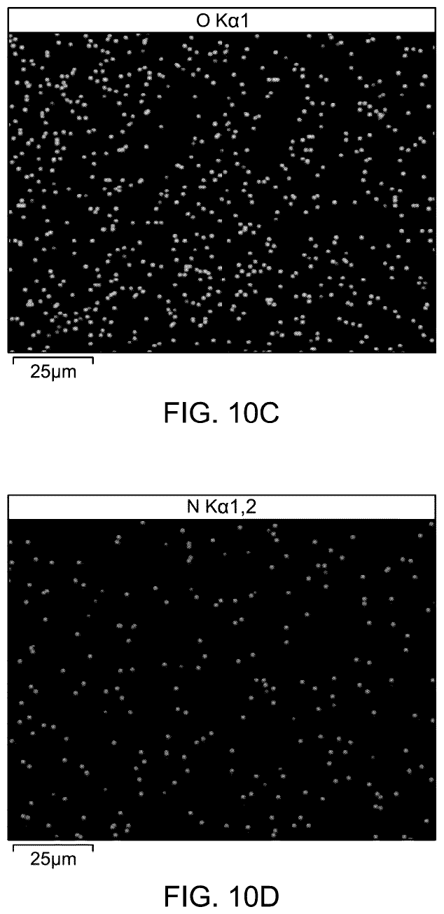

Coupled with EDX analysis is the elemental mapping analysis where the distribution of the elements in the membrane structure can be visualized. All the elements are equally and uniformly distributed throughout the membranes. In the case of M0, the F and C are dispersed over the entire area of the membrane. M1 and M2 have also shown a uniform distribution of all the elements, including F, C, N, and O, as determined by EDX analysis. FIGS. 10A-10D depict elemental mapping analysis of the M3 membrane which shows the elements are located and distributed across the entire membrane area. The intensities of the mapping dots are representative of the concentration of each element in the membrane-selected area. Fluorine, being more abundant, has denser dots (FIG. 10A) compared to the other elements of C, O, and N (FIG. 10B-FIG. 10D). Nitrogen is the least abundant element in the membrane structure which can be justified because the N element is present only due to DABA. The concentration of O is more than that of N owing to the presence of O in amide linkages (—CONH) as well as —COOH groups of DABA. The chemical composition of the membranes revealed the complete decoration of the DAIP-based polymer in the matrix of the membranes.

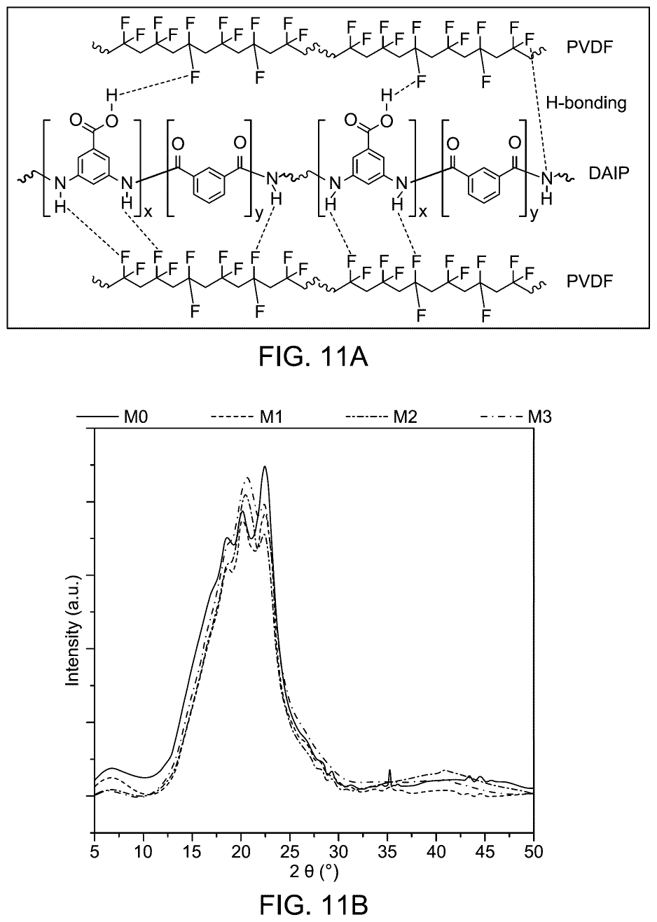

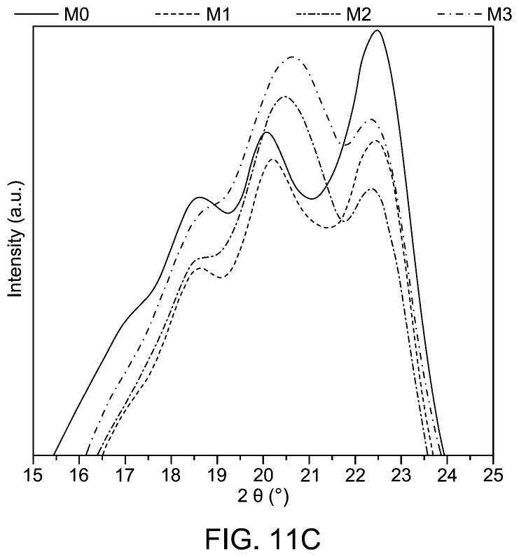

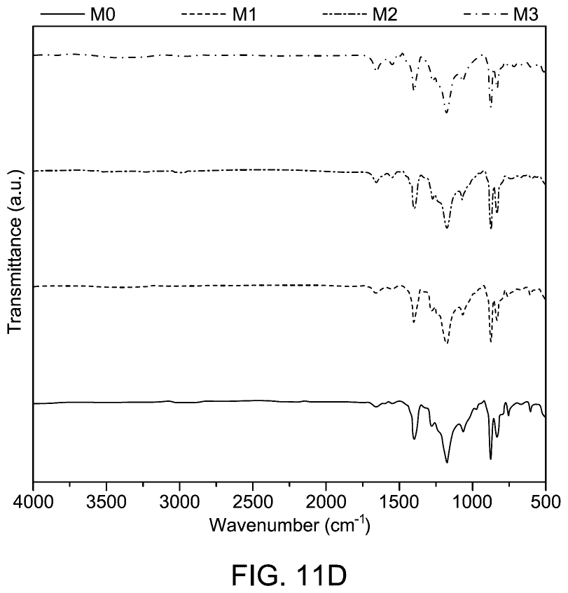

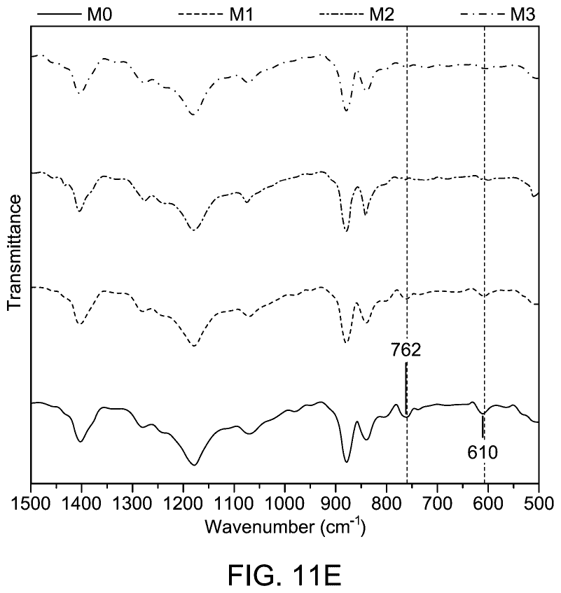

FIG. 11A depicts interactions between the DAIP-based polymer and PVDF where there is a possibility of strong hydrogen bonding between hydrogen bond donor groups of the DAIP-based polymer and hydrogen bond acceptor F atoms of the PVDF polymer. Both polymers develop strong mutual interactions between the two polymers leading to a homogeneous polymeric framework. Other characteristics of the membranes were studied by powder XRD where the base polymer PVDF showed variations upon the introduction of the DAIP-based polymer in the membrane matrix (FIGS. 11B-11C). A powder XRD diffractogram of pristine PVDF membrane, M0, showed diffraction peaks at 2θ=17.0°, 18.5°, 20.0°, 22.5°, and 27.0°, which are attributed to the (100), (020), (110), (200) and (021) planes of the PVDF, respectively [Tsonos, C. et al., Multifunctional nanocomposites of poly(vinylidene fluoride) reinforced by carbon nanotubes and magnetite nanoparticles, Express Polymer Letters, 2015, 9, which is incorporated herein by reference in its entirety]. Decoration with the DAIP-based polymer led to two variations in the PVDF matrix membranes, variations in intensities and positions of the PVDF polymer. Intensities of the peaks at 2θ=17.0°, 18.5°, 22.5°, and 27.0° showed a slight decline, whereas the peak at 2θ=20.0° showed an increase in intensity and a shift in the position of the peak to 2θ=20.8° with increasing dosage of the DAIP-based polymer in the PVDF matrix. These observations confirmed interactions between the DAIP-based polymer and the PVDF, as depicted in FIG. 11A. FTIR spectra of the membranes was used to identify functional groups present in the membranes. Peaks of the PVDF membrane can be seen in all the membranes until the M3 membrane where the peaks due to the DAIP-based polymer also start to appear. The broad band of —OH and —NH of —COOH and —CONH, respectively, are given in the range from 3800 cm⁻¹ to 3400 cm⁻¹. The peak due to the >C═O group can also be seen at around 1700 cm⁻¹ and 1600 cm⁻¹ due to the DAIP-based polymer (FIG. 11D). The peaks of PVDF are depicted in FIG. 11E, which were found to be at 1400 cm⁻¹, 1180 cm⁻¹, 880 cm⁻¹, 830 cm⁻¹, 762 cm⁻¹, and 610 cm⁻¹. The peaks at 1180 cm⁻¹, and 830 cm⁻¹ are due to symmetric —CF₂ stretching vibrations of the PVDF [He, T. et al., Poly(vinylidene fluoride) (PVDF) membrane fabrication with an ionic liquid via non-solvent thermally induced phase separation (N-TIPs), Applied Water Science, 2022, 12, 42, which is incorporated herein by reference in its entirety].

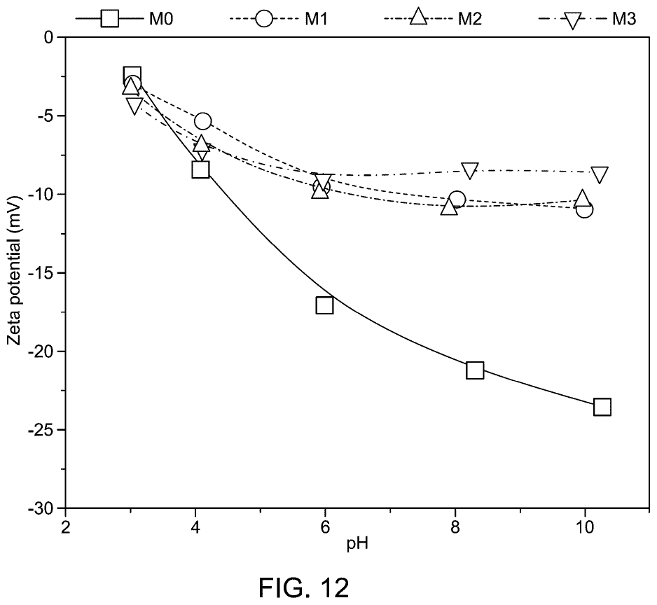

The streaming surface zeta potential of the membranes was studied to understand the chemical features and performance of the membranes during the filtration conditions. The surface of the control PVDF membrane appeared to be negative at all the pH ranges, with a surface zeta potential of −2.5 mV to −22.5 mV. PVDF membranes have been seen to possess a negative surface charge [Kakihana, Y. et al., Preparation of positively charged PVDF membranes with improved antibacterial activity by blending modification: Effect of change in membrane surface material properties, Colloids and Surfaces A: Physicochemical and Engineering Aspects, 2017, 533, 133-139, which is incorporated herein by reference in its entirety]. The negative charge over the PVDF membrane is attributed to the highly electronegative element F found in the PVDF. Due to the highly electronegative nature of the F atom, the C—F bond becomes highly polarized with a strong negative charge on the F, resulting in an overall negative charge on the PVDF membrane [Park, S. Y. et al., Anti-scaling ultrafiltration/microfiltration (UF/MF) polyvinylidene fluoride (PVDF) membranes with positive surface charges for Ca²⁺/silica-rich wastewater treatment, Journal of Membrane Science, 2015, 480, 122-128, which is incorporated herein by reference in its entirety]. A molecular dynamic simulation has shown that the water/hydrophobic interface on the PVDF membrane has adsorbed hydroxide ions which has been supported by experimental findings [Guo, J. et al., Fouling behavior of negatively charged PVDF membrane in membrane distillation for removal of antibiotics from wastewater, Journal of Membrane Science, 2018, 551, 12-19, which is incorporated herein by reference in its entirety]. Upon the addition of the DAIP-based polymer, the surface zeta potential became less negative (−3.0 mV to −11.5 mV) across all pH values. These changes in the surface charge of the DAIP-decorated membranes indicate that the membrane matrix and surface have changed their chemistry (FIG. 12). Alterations in the surface charge of the DAIP-decorated membranes can be attributed to factors such as the presence of —COOH, amide (—CONH), and phenyl rings in the structure of the DAIP-based polymer. —COOH and —CONH functional groups can develop hydrogen bonding interactions with the fluoride (F) atoms of the PVDF membrane. The negative charge of the F atoms is shared with the electropositive hydrogen atoms of the —OH and —NH groups of —COOH and —CONH groups, respectively. At basic pH ranges, the —COOH groups are deprotonated, leading to —COO⁻, and the surface of the DAIP-decorated membranes become more polar and develop strong interactions with water molecules, and the concentration of hydroxide groups is decreased on the membrane surface as the water/hydrophobic interface is changed into water/hydrophilic phase. These features are desirable for efficient O/W emulsion separation owing to underwater superoleophobic nature of the DAIP-decorated membranes.

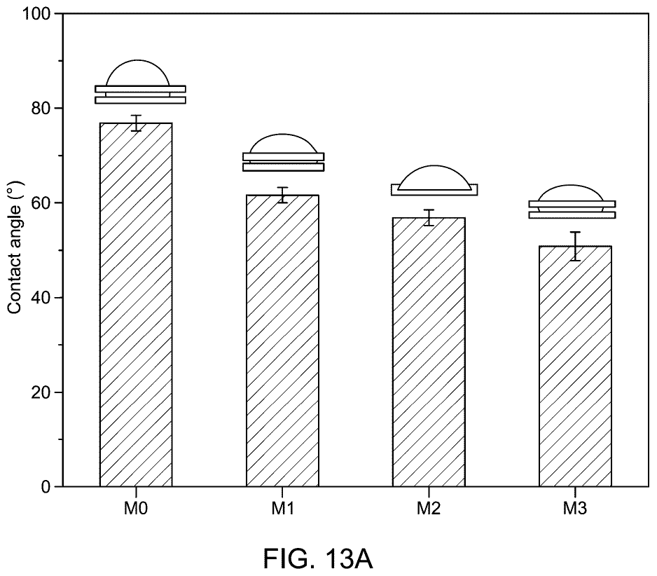

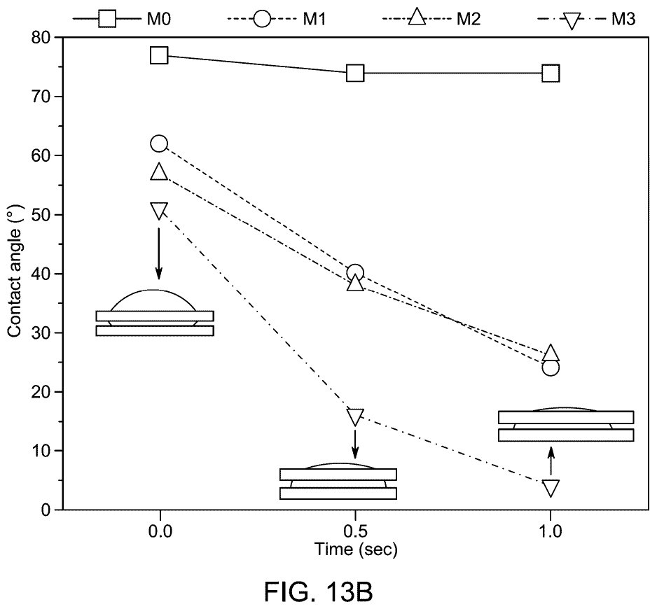

Among the various surface features of the membranes, surface wettability may determine performance of the membranes. To determine surface wettability of the membranes, the static and dynamic water contact angles (WCAs) of the membranes were performed and are shown in FIGS. 13A-13B. The membranes become more hydrophilic upon addition of the DAIP-based polymer into the membrane matrix. Compared to pristine PVDF membrane (M0) with a WCA of 77°, the WCAs of the DAIP-decorated membranes decreased. This decrease becomes more obvious with an increasing dosage of the DAIP-based polymer which means that the membranes become more hydrophilic. The WCAs of M1, M2, and M3 were found to be 62°, 57°, and 51°, respectively when, measured immediately after dropping the water droplet on the membrane surface (FIG. 13A). The WCAs of the membranes in dynamic mode revealed a superhydrophilic nature of the membranes, especially M3 which showed a WCA approaching 0° in about 3 seconds of contacting a water droplet on the membrane surface (FIG. 13B). The inset images in FIG. 13B show a decrease in the WCA of the M3 membrane over time. In contrast to the DAIP-decorated membranes, pristine PVDF membrane (M0) showed a minor decrease in WCA with a variation of 77° to 75°, which shows that the PVDF membrane is hydrophobic compared to the DAIP-decorated membranes. PVDF is known to have a hydrophobic nature due to excessive content of F atoms in the polymer backbone [Kaynak, A. et al., Study of Radio Frequency Plasma Treatment of PVDF Film Using Ar, O₂ and (Ar+O₂) Gases for Improved Polypyrrole Adhesion, Materials, 2013, 3482-3493, which is incorporated herein by reference in its entirety]. The presence of the DAIP-based polymer in M1, M2, and M3 leads to a decrease in WCA owing to the presence of hydrogen bonding groups-COOH and —CONH which can develop hydrogen bonding interactions with water molecules developing a hydration layer on the membrane surface which, in turn, lowers the WCAs of the DAIP-decorated membranes. The chemistry of the membrane surface is of importance in determining physical and chemical properties which assist in understanding the separation behavior of the membranes during filtration conditions.

Like membrane surface charge and wettability, another feature of the membranes is their surface roughness which plays a role in contributing to the performance of the membranes during filtration. An increase in surface roughness of a membrane causes a decrease in WCAs, resulting in increased hydrophilicity of the membrane. M0 possessed a smooth membrane surface with an average surface roughness (Sₐ) of 38 nm and a squared average surface roughness (S_{q}) of 50 nm. Membrane surfaces showed an increased roughness, from M1 to M3, which may be attributed to the different coagulation mechanisms of the DAIP-based polymer during phase inversion, resulting in the setting up of the PVDF chains in a rougher way. Compared to M1 with a lower percentage of the DAIP-based polymer, M2 and M3 showed an increase in surface roughness, as shown in Table 2. This phenomenon is based on the chemistry of the DAIP-based polymer which is hydrophilic due to —COOH and —CONH but also has a hydrophobic backbone composed of aromatic benzene rings of DABA and IPC. The hydrophobic backbone of the DAIP-based polymer develops strong secondary interactions with the PVDF polymer, whereas the hydrophilic moieties of the DAIP-based polymer develop strong hydrophilic interactions with water molecules during phase inversion. Phase inversion of the DAIP-decorated membranes occurs in different modes resulting in increased surface roughness.

TABLE 2
Surface roughness analysis of M0 and DAIP
decorated M1, M2, and M3 membranes

| Membrane | Sa (nm) | Sq (nm) |
|---|---|---|
| M0 | 38 | 50 |
| M1 | 54 | 67 |
| M2 | 165 | 234 |
| M3 | 135 | 193 |

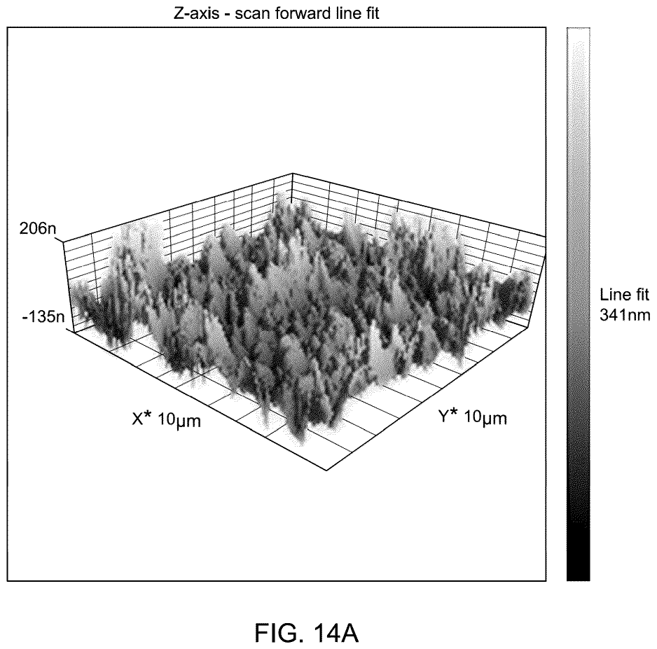

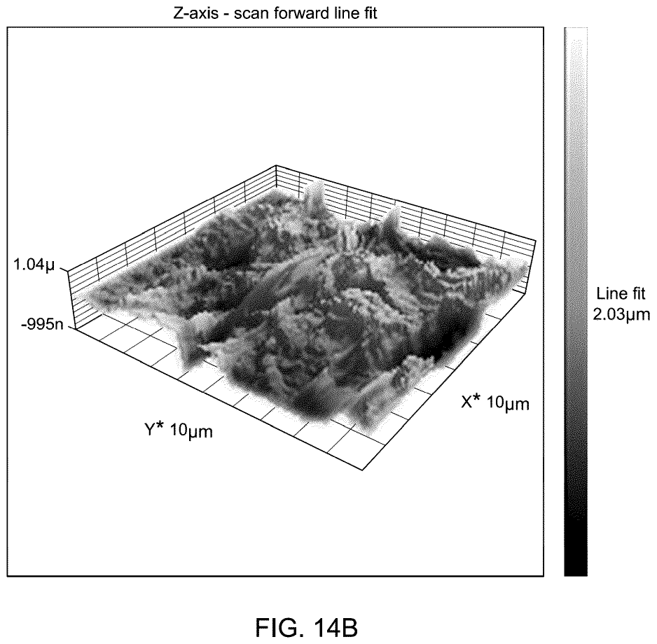

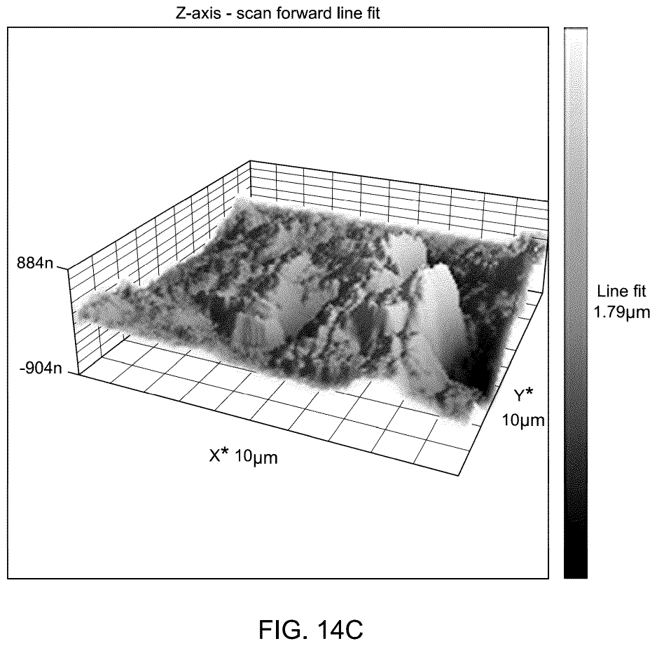

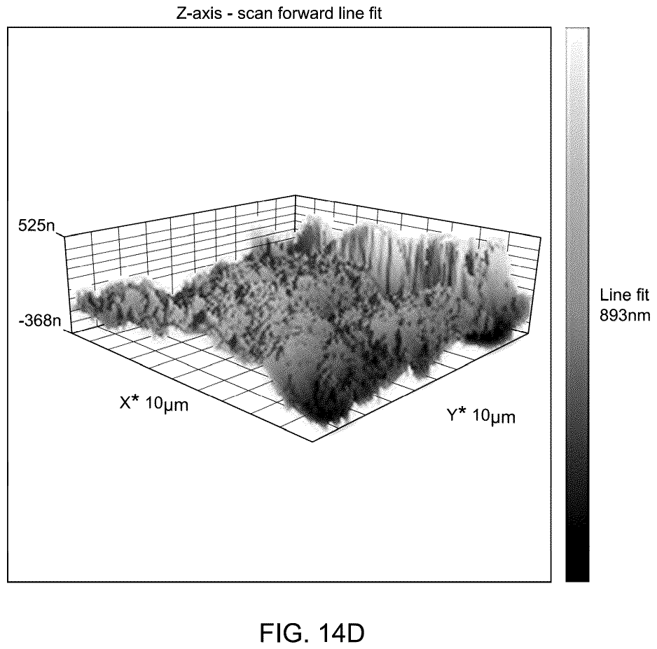

Three-dimensional (3D) images show variations in the membrane surface roughness and the existence of fine ridges and valleys over the entire area of the M0 membrane (FIG. 14A). Images of M1 (FIG. 14B), M2 (FIG. 14C), and M3 (FIG. 14D) depict the valleys becoming deeper surrounded by more mountainous regions (ridges), which are also reflected in the surface roughness values given in Table 2. Inclusion of the DAIP-based polymer in the PVDF membrane results in altered surface topography of the membranes.

The Young-Dupre equation was used to determine relative membrane surface wettability by determining the membrane-liquid interfacial free energy (−ΔG_{ML}), where the liquid is water.

$$- Δ {G}_{ML} = {ℽ}_{L} ( 1 + cos θ ) \qquad ( 3 )$$

where the “γ_{L}” is surface tension of pure water, “θ” is the measured water contact angle of the membranes. Generally, a larger value −ΔG_{ML} means a more wettable surface.

Various components of membrane surface tension were determined by using the extended Young-Dupre equation as given in equation 4:

$${γ}_{L} ( 1 + cos θ ) = 2 ( \sqrt{{γ}_{M}^{LW} {γ}_{L}^{LW}} + \sqrt{{γ}_{M}^{AB +} {γ}_{L}^{AB -}} + \sqrt{{γ}_{M}^{AB -} {γ}_{L}^{AB +}} ) \qquad ( 4 )$$

where “M” stands for membrane, “L” represents liquid, and

$$“ {γ}_{M}^{LW} , {γ}_{L}^{LW} {γ}_{M}^{A B +} , and γ {A}_{L}^{AB -} ”$$

represent the membrane surface tension components due to Lifshitz-van der Waals forces, Lewis acid-base acceptor, and donor components of the membrane. The other contact angles of the membranes were measured using different polar and non-polar solvents. The polar solvents include water and ethylene glycol, and non-polar solvents include diiodomethane. The total surface energy of the membrane can be expressed by equation 5:

$${γ}^{TOT} = {γ}^{AB} + {γ}^{LW} \qquad ( 5 )$$

where the value of γ^{AB}=2\sqrt{γ^{AB}+γ^{AB-}}.

Equation 4 adopts the form of equation 6:

$$( {γ}_{L}^{LW} + 2 \sqrt{{γ}_{L}^{AB +} {γ}_{L}^{AB -}} ) ( 1 + cos θ ) = 2 ( \sqrt{{γ}_{M}^{LW} {γ}_{L}^{LW}} + \sqrt{{γ}_{M}^{AB +} {γ}_{L}^{AB -}} + \sqrt{{γ}_{M}^{AB -} {γ}_{L}^{AB +}} ) \qquad ( 6 )$$

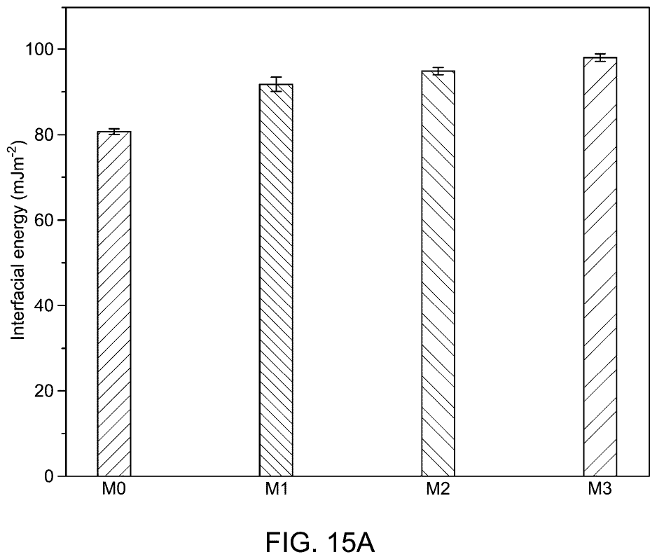

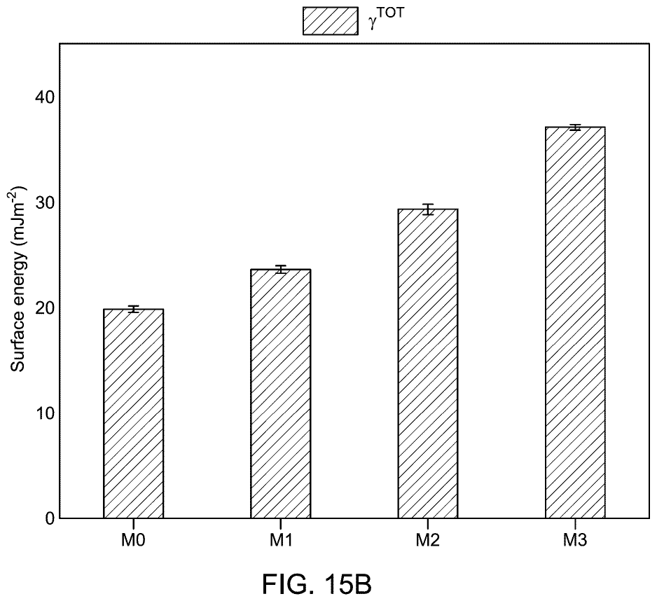

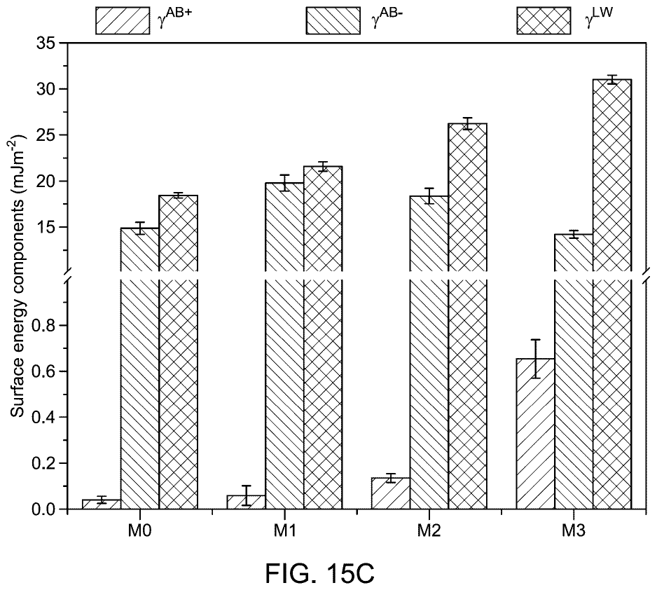

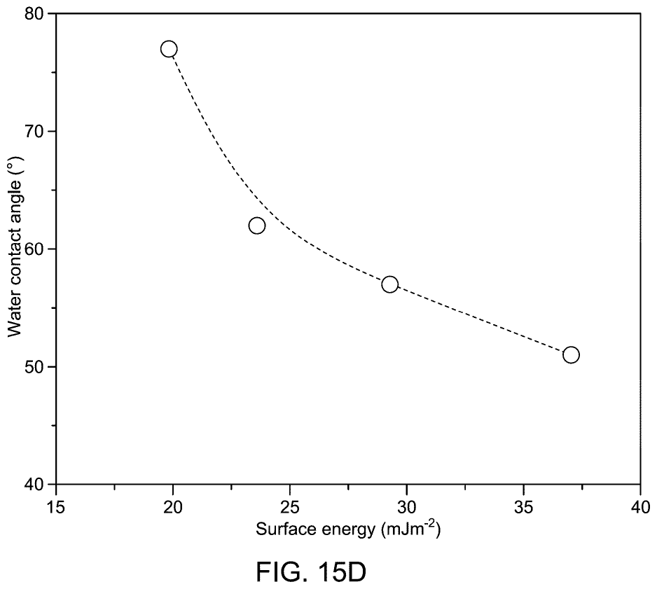

The surface wettability of the membranes was investigated by measuring interfacial free energy and surface energy of the membranes. The pristine PVDF membrane, M0, was found to be wetting with the interfacial free energy of −ΔG_{ML}=80 mJ/m² (FIG. 15A). Similarly, the surface free energy of M0 was found to be the lowest, with a value of 20 mJ/m² (FIG. 15B), compared to other membranes. The main component responsible for the surface energy of M0 is Lifshitz-van der Waals forces γ^{LW} (FIG. 15C), which can be attributed to the presence of hydrophobic C—F bonds in the PVDF membrane. Upon the decoration of hydrophilic the DAIP-based polymer in the membrane matrix, the surface energy parameters were altered, and an increase in interfacial and surface free energies was observed. The surface energies showed a linear increase with increasing the dosage of the DAIP-based polymer in the membrane matrix. The highest interfacial and surface free energies were calculated for M3 with values of 98 mJ/m² and 37 mJ/m², respectively, owing to the presence of a higher dosage of the DAIP-based polymer in M3. A continuous increase in the surface energy of the membrane with a high dosage of the DIAP-based polymer indicates more exposure of the hydrophilic DIAP-based polymer towards the surface. Although γ^{LW} is a large component responsible for this increase, another observation was an increase in the Lewis acceptor component, γ^{AB+}, coupled with a decrease in the Lewis donor component, γ^{AB-}. These observations exhibit that the membrane surface chemistry has altered with increasing the dosage of the DAIP-based polymer in the PVDF matrix. This may be attributed to the presence of —COOH groups in the DAIP-based polymer. —COOH acid groups are also a source of protons (H⁺) which act as Lewis acid acceptors. Owing to the presence of —COOH on the membrane surface, the membrane develops strong interactions with the water molecules and results in higher surface energies, making the membranes more hydrophilic. FIG. 15D shows the membranes become more hydrophilic with an increase in the surface energy of the membranes. Increased hydrophilicity of the membranes contributes to efficient separation of O/W surfactant-stabilized emulsions. The evolution of hydrogen bonding interactions between the F atoms of C—F bonds and the H atoms of —COOH and —CONH functional groups alters the surface wetting properties of the membranes. The DAIP-decorated membranes become more hydrophilic compared to the pristine PVDF membrane.

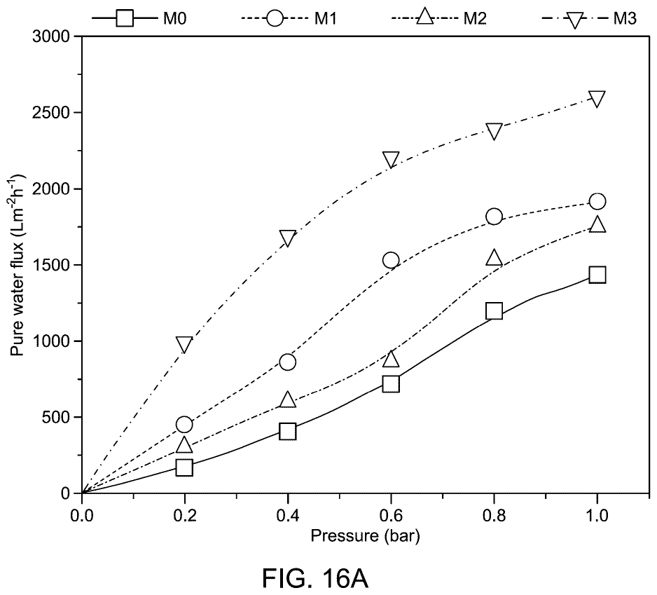

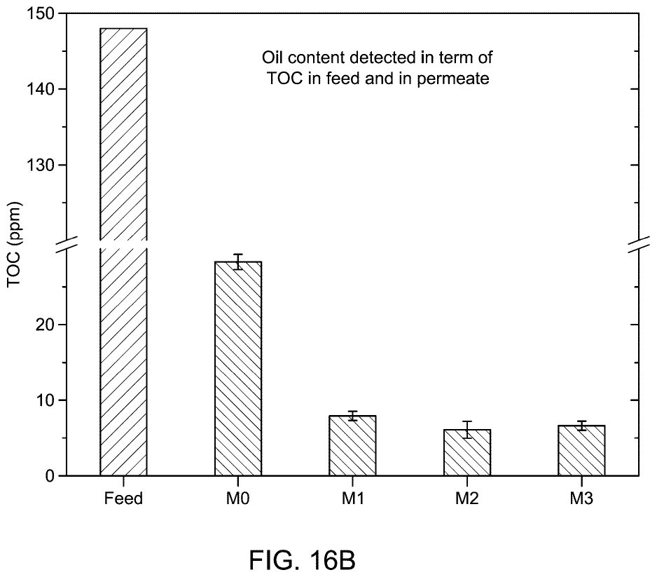

Oil/water (O/W) emulsion separation was performed using a crossflow filtration system where membranes were compacted using DI water as a feed until a steady permeate flux was achieved. Following compaction with DI water, the effect of a feed pressure on permeate flux was studied, as shown in FIG. 16A. An increase in permeate flux was observed with an increase in feed pressure for all the membranes. Permeate flux also increased with an increasing dosage of the DAIP-based polymer in the membrane structure. This can be attributed to the increased hydrophilicity of the membranes with increasing DAIP-based polymer dosage in the membrane matrix. An increase of 85% in the permeance was recorded in the case of M3 compared to M0. A permeance of 2600 L m⁻² h⁻¹ bar⁻¹ was recorded for M3 compared to a permeance of 1430 L m⁻² h⁻¹ bar⁻¹ for M0. The DAIP-decorated membrane showed good total organic carbon (TOC) removal during O/W emulsion separation. M3 decreased the TOC content of the feed from 148.1 ppm to 6 ppm, resulting in almost complete separation of oil and water. The control membrane, M0, reduced the TOC to 30 ppm (FIG. 16B). The higher TOC removal capacity of M3 can be attributed to the hydrophilic nature of the DAIP-based polymer. Due to the hydrophilic nature of M3, a strong hydration layer is built up on the surface of the membrane developing an oil-repelling feature for the membrane. The oil is then rejected by the membrane while water is permeated through the membrane during O/W emulsion separation. Decorating a hydrophilic polyamide polymer in a PVDF matrix is advantageous in improving the permeance of a membrane and increases O/W emulsion separation capabilities of a membrane. This is attributed to the increased homogeneity between the DAIP-based polymer and the PVDF polymer, leading to defect-free membranes for O/W separation.

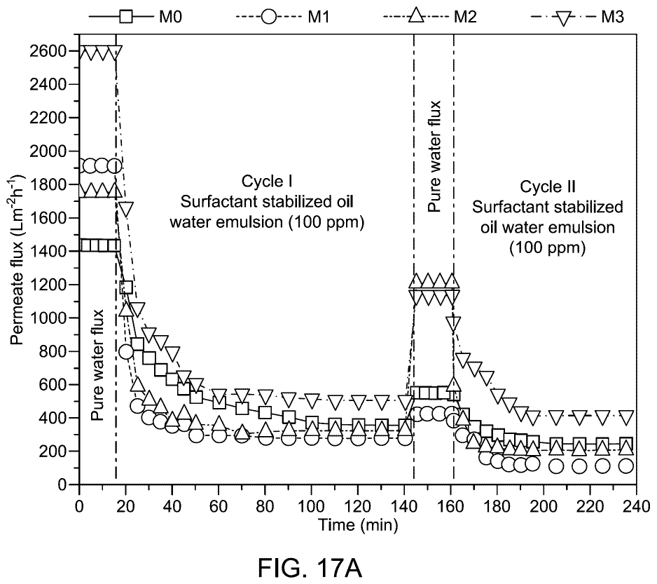

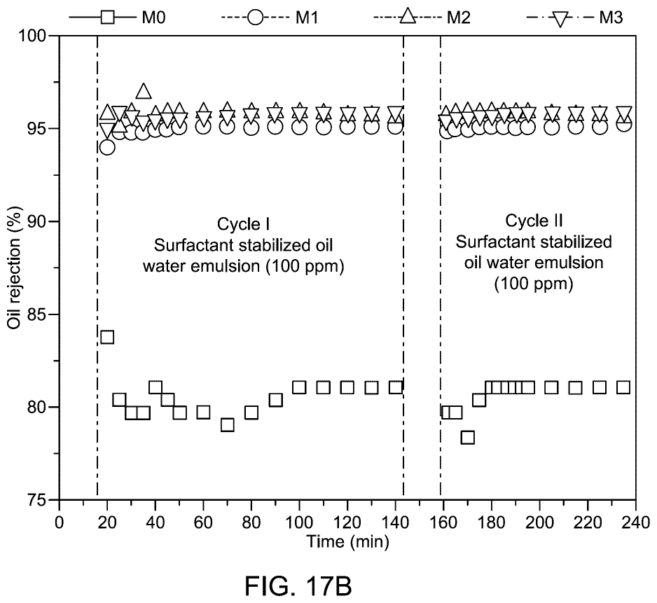

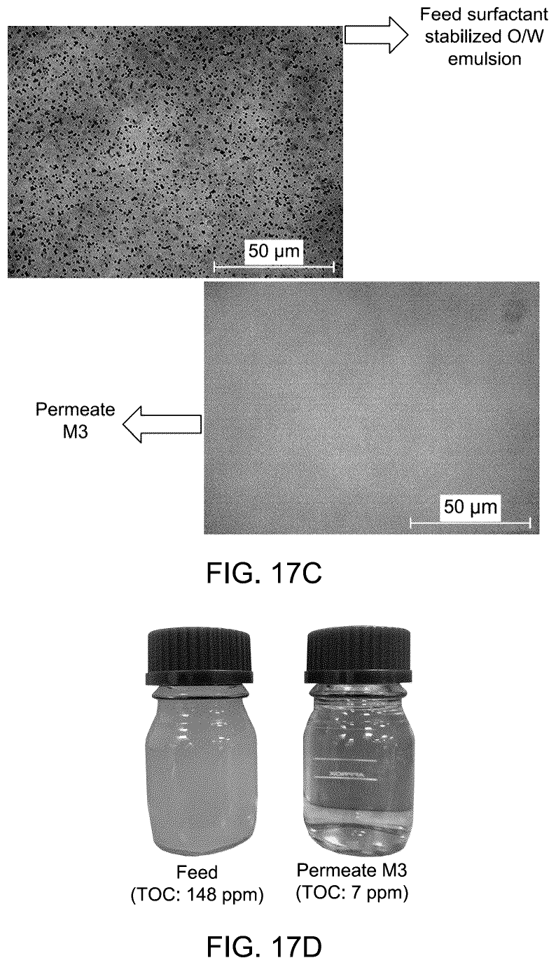

Following O/W separation, long-term O/W separation behavior of the membranes was tested for 240 minutes in a crossflow filtration mode. Initially, the membranes underwent rapid fouling where the permeance decreased from 2600 L m⁻² h⁻¹ bar⁻¹ to 600 L m⁻² h⁻¹ bar⁻¹ in 30 minutes for M3. Permeance for M3 was decreased to 500 L m⁻² h⁻¹ bar⁻¹ in the next 30 minutes and remained stable up to 140 minutes. M0 showed a decrease in permeance from 1400 L m⁻² h⁻¹ bar⁻¹ to 320 L m⁻² h⁻¹ bar⁻¹ from 0 minutes to 140 minutes. The initial rapid fouling of the membrane can be attributed to the availability of a greater number of active sites for binding the foulants on the membrane surface. Although the control membrane showed a lower fouling tendency compared to the DAIP-decorated membranes (especially M3), M0 showed an irreversible fouling. Given the hydrophobic nature of oil, it can develop an attraction with the PVDF membrane causing oil to adsorb on the membrane surface. This was confirmed by a cleaning cycle of the membranes where M3 was able to recover its permeance compared to M0. The permeance of the M3 membrane was recovered to reach 1200 L m⁻² h⁻¹ bar⁻¹ after 20 minutes of cleaning with DI water, which was a higher recovery compared to M0. The permeance of M0 was recovered to reach 600 L m⁻² h⁻¹ bar⁻¹ upon cleaning with DI water (FIG. 17A). During the second cycle of the O/W separation experiments, M3 and M0 showed the same fouling behavior as was observed for cycle one. The increased resistance of M3 highlights the hydrophilic DAIP-based polymer decorated in the matrix of the PVDF polymer which resists the attachment of oil on the membrane surface by establishing a hydration layer on the membrane surface. If the hydrophobic components are attached to M3, the presence of hydrophilic functional groups, like —COOH and —CONH, prefers water molecules to bind the membrane surface during the cleaning cycle which results in recovering the permeance of the membranes. In the case of O/W separation efficiency, it remained about the same during the duration of the membrane testing, especially for the DAIP-decorated membranes. The separation of oil from water remained >96% for the DAIP-decorated membranes compared to the 79% separation capability of M0 (FIG. 17B). Decoration of the DAIP-based polymer enhanced the permeance and the separation efficiency of the DAIP-decorated membranes.

Confirmatory evidence was obtained by light microscopic images of the feed and permeates obtained from the membranes (FIG. 17C). The feed showed a suspension composed of a highly dispersed oil in the water in the form of micro-droplets which were stabilized by the surfactants. In the case of permeates, especially for the permeates collected from M3, there was no visible evidence of any dispersed oil droplets in the permeates. In the case of M0 and M1, the oil droplets are visible in the form of a diluted suspension. The results obtained for the M3 membrane regarding O/W separation are supported by the optical microscopy images of the emulsion. Digital photographs of the experimental feed and permeate samples are shown in FIG. 17D.

Synthesis, characterization, and integration of a DAIP-based polymer into PVDF have resulted in varying structural, chemical, and physical features of membranes, M1, M2, and M3, compared to a pristine PVDF membrane, M0. The structure of the DAIP-based polymer and its decoration in the PVDF membrane was confirmed through techniques such as ¹H-NMR, SEM, FE-TEM, EDX, XRD, FTIR, WCAs, and surface zeta potential measurements. The presence of characteristic ¹H-NMR peaks, elemental composition, and surface properties, such as roughness and wettability, highlight the effective incorporation of the DAIP-based polymer into PVDF in the membranes. These changes in the membrane features led to improved water permeability and oil/water separation efficiency. The membranes exhibited increased permeate flux and total organic carbon (TOC) removal capacity, especially with higher concentrations of the DAIP-based polymer, which marked the utility of the hydrophilic polyamide in developing polymeric membranes with enhanced performance. The membranes initially showed fouling during O/W separation, which was found to be reversible in the case of M3 with a 46% recovery of permeance reaching 1200 L m⁻² h⁻¹ bar⁻¹ compared to a 41% recovery of permeance reaching 600 L m⁻² h⁻¹ bar⁻¹ for M0. M3 was able to retain double permeance compared to M0. M3 was able to retain a higher separation efficiency of >96% during both cycles of the fouling and cleaning compared to the 79% separation efficiency of M0. Integration of the DAIP-based polymer into PVDF membranes represents an approach for developing efficient membranes with enhanced separation performance, particularly in O/W emulsion separation applications with resistance to fouling compared to pristine membranes.

Numerous modifications and variations of the present disclosure are possible in light of the above teachings. It is therefore to be understood that within the scope of the appended claims, the disclosure may be practiced otherwise than as specifically described herein.

1. A mixed matrix membrane, comprising:
a polymer comprising reacted units of a 3,5-diaminobenzoic acid and isophthaloyl chloride in a molar ratio of 5:1 to 1:5; and
a polyvinylidene fluoride,
wherein a weight ratio of the polymer to the polyvinylidene fluoride is from 1:1 to 1:20 based on a total weight of the polymer and the polyvinylidene fluoride,
wherein the polymer and the polyvinylidene fluoride form a trilayer structure of horizontal layers with a first porous outer layer of the polyvinylidene fluoride and a second porous outer layer covering a porous inner layer of the polymer,
wherein the first porous outer layer has a pore size with a longest dimension of 3 to 30 μm,
wherein the second porous outer layer has a pore size with a longest dimension of 1 to 10 μm,
wherein the porous inner layer has void spaces having an average longest dimension of from 20 to 500 μm,
wherein amine groups and carboxyl groups in the polymer and fluorine in the polyvinylidene fluoride form hydrogen bonds between the horizontal layers.

2. The mixed matrix membrane of claim 1, wherein the reacted units of the 3,5-diaminobenzoic acid and the isophthaloyl chloride are connected by an amide bond.

3. The mixed matrix membrane of claim 1, wherein the membrane is porous and has an average pore size of 0.5 to 5 μm.

4. The mixed matrix membrane of claim 1, wherein the membrane has a thickness of 50 to 500 μm.

5. The mixed matrix membrane of claim 1, wherein the horizontal layers are denser at a top section of the membrane and a bottom section of the membrane than they are in a middle section of the membrane.

6. The mixed matrix membrane of claim 1, wherein the membrane comprises fluorine in an amount of 40 to 60 percent by weight (wt. %), carbon in an amount of 40 to 50 wt. %, nitrogen in an amount of 0.1 to 2 wt. %, and oxygen in an amount of 2 to 5 wt. % based on a total weight of the membrane.

7. The mixed matrix membrane of claim 1, wherein the membrane has a surface zeta potential of −1 to −15 mV.

8. The mixed matrix membrane of claim 1, wherein the membrane has a water contact angle of 45 to 65°.

9. The mixed matrix membrane of claim 1, wherein the membrane has an average surface roughness of 50 to 175 nm.

10. The mixed matrix membrane of claim 1, wherein the membrane has a squared average surface roughness of 60 to 250 nm.

11. The mixed matrix membrane of claim 1, wherein the membrane has an interfacial energy of 90 to 100 mJ/m².

12. The mixed matrix membrane of claim 1, wherein the membrane a surface energy of 20 to 40 mJ/m².

13. The mixed matrix membrane of claim 1, wherein the membrane has a total organic carbon removal efficiency of 90 to 99% based on an initial amount of carbon in a sample.

14. The mixed matrix membrane of claim 1, wherein the membrane has a permeate flux of 2500 to 2700 L m² h⁻¹ bar⁻¹ for water.

15. The mixed matrix membrane of claim 1, wherein the polymer has a weight ratio of oxygen to nitrogen from 1:1 to 4:1.

16. The mixed matrix membrane of claim 1, wherein the polymer comprises carbon in an amount of 55 to 65 percent by weight (wt. %), nitrogen in an amount of 10 to 15 wt. %, and oxygen in an amount of 25 to 30 wt. % based on a total weight of the polymer.

17. The mixed matrix membrane of claim 1, wherein the polymer is in the shape of agglomerated flakes having a longest dimension of 5 to 50 μm.

18. The mixed matrix membrane of claim 1, wherein the polymer is made by a process, comprising:
dissolving 3,5-diaminobenzoic acid in dimethylacetamide to form a first solution;
dissolving isophthaloyl chloride in dimethylacetamide to form a second solution;
chilling the first solution to a temperature of −10 to 10° C.;
mixing the first solution and the second solution for 2 to 4 hours at a temperature of −10 to 10° C. to form a reaction mixture;
mixing the reaction mixture for 10 to 15 hours temperature of 15 to 35° C. to form the polymer in the reaction mixture;
adding a chloride salt and a carbonate salt to the reaction mixture;
isolating the polymer from the reaction mixture; and
washing and drying the polymer.

19. A method of filtration, comprising:
flowing a mixture through the mixed matrix membrane of claim 1,
wherein the mixture comprises one or more oils and water,
collecting a permeate,
wherein the permeate has a lesser amount of the one or more oils than the mixture.

20. The method of claim 19, further comprising:
washing the membrane;
flowing the mixture through the membrane; and
collecting the permeate,
wherein the membrane has an oil-and-water separation rate of at least 90% of an initial oil-and-water separation rate.
